(19) United States
(12) Patent Application Publication
(10) Pub. No.: US 2005/0259682 A1
(43) Pub. Date: Nov. 24, 2005

(54) Broadcast system

(76) Inventors: Yuval Yosef, Hadera (IL); Haim Neerman, Hadera (IL); Doron Rajwan, Givataim (IL); Edan Ayal, Kfar-Saba (IL)

Correspondence Address: WOLF, BLOCK, SCHORR & SOLIS-COHEN LLP, 250 PARK AVENUE, NEW YORK, NY, 10177, US

(21) Appl. No.: 10/182,753

(22) PCT Filed: Feb. 2, 2001
(86) PCT No.: PCT/IL01/00107

§ 371 Date: Sep. 26, 2003

Related U.S. Application Data
(60) Provisional application No. 60/179,926, filed on Feb. 3, 2000.
(60) Provisional application No. 60/217,139, filed on Jul. 10, 2000.
(60) Provisional application No. 60/245,000, filed on Nov. 1, 2000.
(60) Provisional application No. 60/245,098, filed on Nov. 2, 2000.

(30) Foreign Application Priority Data
Aug. 1, 2000 (IL) 137624
Aug. 27, 2000 (IL) 138114
Dec. 24, 2000 (IL) 140504

(51) Int. Cl. H04J 3/16

(52) U.S. Cl. 370/468

(57) ABSTRACT

A method of emulating an interactive connection, comprising: generating a request for interactive data from an interactive server, at a client; intercepting said request by an agent; responsive to said request, retrieving at least some of said data from a continuous retransmission of said data, by said agent; and displaying said data including said retrieved data at said client.

### RELATED APPLICATIONS

This application is related to and claims the benefit under 35 USC 119(e) of U.S. Ser. No. 60/179,926 filed on Feb. 3, 2000, U.S. Ser. No. 60/217,139 filed on Jul. 10, 2000, U.S. Ser. No. 60/245,000 filed on Nov. 1, 2000 and U.S. Ser. No. 60/245,098 filed on Nov. 2, 2000. This application is also related to Israeli applications 137,624 filed on Aug. 1, 2000, 138,114 filed on Aug. 27, 2000 and 140,504 filed Dec. 24, 2000. This application is also related to two PCT applications filed on even date and by same applicant as the instant application, having attorney docket numbers 212/01968 and 212/02064. The disclosure of all of these applications is incorporated herein by reference.

### FIELD OF THE INVENTION

The present relates to content delivery of information, and in particular to broadcasting over computer networks, such as the Internet.

### BACKGROUND

Broadcasting of information over the Internet, from a single (or multiple) source to a plurality of target users has long been suggested in the art and is known as “multi-casting”. One problem with multi-casting is the lack of interactivity. Another problem is that many parts of the Internet do not support the available multi-casting standards.

The Internet, in general, suffers from a lack of bandwidth. It is known that many Internet users access the same data sources. Such knowledge, even though it has spawned a wealth of caching schemes, has not substantially solved the bandwidth problem and the Internet is commonly known as the “world wide wait”.

K. Elmeroth and M. Ammar “Scalable delivery of web pages using cyclic best-effort (UDP) multicast” in proceeding of IEEE infocom (San Francisco Calif.) June 1998, the disclosure of which is incorporated herein by reference, describes a multi-casting system in which data (e.g., a set of popular WWW pages) is continuously resent using a data carrousel.

Various coding schemes are described in Byers, J. W., Luby, M., Mitzenmacher, M., and Rege, A., “A Digital Fountain Approach to Reliable Distribution of Bulk Data”, Proceedings ACM SIGCOMM '98, Vancouver, Canada, September 1998, Luby, M., Mitzenmacher, M., Shokrollahi, A., Spielman, D., Stemann, V., “Practical Loss-Resilient Codes” 29th STOC'97, Rizzo, L, and Vicisano, L., “Reliable Multicast Data Distribution protocol based on software FEC techniques”, Proceedings of the Fourth IEEE Workshop on the Architecture and Implementation of High Performance Communication Systems, HPCS-97, Chalkidiki, Greece, June 1997, Rizzo, L., “Effective Erasure Codes for Reliable Computer Communication Protocols”, ACM SIGCOMM Computer Communication Review, Vol. 27, No. 2, pp. 24-36, April 1997 and Rizzo, L., “On the Feasibility of Software FEC”, DEIT Tech Report, http://www.iet.unipi.it/˜luigi/softfec.ps, January 1997, the disclosures of which are incorporated herein by reference. Some of these coding methods allow a file to be reconstructed when any set of N packets encoding the file are received. It is suggested, in at least one of the papers, that one of these coding schemes be used for multi-casting of data.

Microsoft corporation technical report MSR-TR-99-14, Mar. 17, 1999, the disclosure of which is incorporated herein by reference describes a software update and distribution tool called F-CAST that distributes software updates, by multi-cast, to a plurality of users

### SUMMARY OF THE INVENTION

An aspect of some embodiments of the invention relates to providing an interactive protocol, such as HTTP, using a one-way protocol, such as multicasting or unicasting. In an exemplary embodiment of the invention, data for transmission is multicast at a plurality of addresses, and each client connects to those addresses that contain the data that client needs. Optionally, an index of the channel contents is also multicast. Optionally, a plurality of related files are combined into a single channel. In an exemplary embodiment of the invention, multicasting is thus used for selective and/or active retrieving (“pull”) of information by the clients.

It should be noted, that in some embodiments of the invention, a non-interactive multicasting based data dissemination method is provided.

In a particular implementation of the multicasting system, a WWW server sends data via a multicasting server, where the data is encoded, to clients, where the data is decoded, to be received by users.

In some embodiments of the invention, personalized multicasting is provided, in which data from a multicast is personalized using other data, which may be unicast or multicast, possibly in multiple addresses (and/or different ports of a same address), thus providing a personalized information display for each client. For example, a page background may be multi-cast, while a name of the user is unicast. In an exemplary embodiment of the invention, the combining is performed by a data combination daemon residing at the user's computer. However, such a combining daemon may be part of a browsing software or provided at other locations in the Internet. Alternatively or additionally to utilizing multicasting or standard unicasting, in some embodiments of the invention, the system may use reliable UDP or even unreliable UDP (e.g., standard UDP).

In some embodiments of the invention, the local daemon or other server also serves to provide hints and/or reports, for example cookies and/or other user associated files to the remote server, so that a correct personalized service can be provided.

In an exemplary embodiment of the invention, the multicast data is continuously multicast. In some embodiments of the invention, a data carousel is used. In other embodiments of the invention, the data is encoded using an erasure code, and divided into a plurality of packets, such that the data can be reconstructed once a sufficient number of packets is received. In an exemplary embodiment of the invention, the code is an infinite code, in that a very long substantially unrepeating stream can be generated from the data. In a particular embodiment of the invention, any set of packets of sufficient number can be used to reconstruct the data. Optionally, different receivers can receive at different data rates, since, by the slower computer receiving the same number of packets as a fast computer, only over a longer period of time. Alternatively or additionally, the data is encoded using a pyramidal encoding scheme, such that one set of packets (or multicast address) produces one quality, while receiving two sets of packets produces a second, higher quality. Alternatively or additionally, the code is set up such that the quality of reconstruction increases as a function of the number of packets received. P. A. Chou, A. E. Mohr, A. Wang, and S. Mehrotra, “Error Control for Receiver-driven Layered Multicast of Audio and Video,” IEEE Transactions on Multimedia, available at http://www.research.microsoft.com/˜pachou/publications.htm, the disclosure of which is incorporated herein by reference, describes real-time streaming using error-correction codes.

In an exemplary embodiment of the invention, a service level agreement (SLA or QoS) for the data provider, the user and/or the network is supported by the ability of the multicasting to provide graceful scalability and/or utilization of bandwidth. In some embodiments of the invention, the graceful scalability is provided by the coding scheme. Alternatively or additionally, the graceful scalability is provided by data transmission, data reconstruction and/or interactivity control portions of the multicasting system.

In some embodiments of the invention, the encoding method and/or various parameters thereof are modified to match the instantaneous needs of the system, for example, different packet mixes being sent responsive to the percentage of lost packets. Alternatively or additionally, transmission rate and/or the channels to which a receiver is connected, change.

An aspect of some embodiments of the invention relates to continuously changing the content that is multicast, responsive to an estimation of what the most popular content will be. In an exemplary embodiment of the invention, the estimation of popular content is determined responsive to gathered statistics, for example statistics gathered at the clients, at the WWW servers that provide the content and/or at various parts of the data transmission system. In some cases, the popular content can be pre-fetched from the WWW servers and/or multicast prior to it actually being requested by the users. Alternatively or additionally, the workload estimation is forwarded to the WWW servers, to allow them to prepare for the increased workload. Alternatively or additionally, the multicast data can be pre-fetched to one or more clients. Alternatively or additionally, a content may be broadcast based on an expectation it will be found interesting, even if the data was not requested and/or responsive to a request by a commercial data provider.

In an exemplary embodiment of the invention, a plurality of related files are aggregated together into a single entity that is encoded as a single unit.

In an exemplary embodiment of the invention, the aggregation of files into content groups is based on a geographical distribution, for example, each geographical area having a different set of aggregated files. Optionally, different transmission channels and/or content groups are created for different geographical locations. In some cases, a content group may repeat between locations. In an exemplary embodiment of the invention, each geographical location is served by a different server (which may include cached, encoded, files). Optionally, a hierarchy is defined, in which an agent first attempts to download data from a local channel and if it fails, accesses a more remote channel.

A feature of some embodiments of the invention is that the above cache-like behavior is initiated and/or managed by the data sender or an associated service provider (e.g., the multicasting system), rather than by the receiver. In some embodiments of the invention, the caching is performed at general or dedicated cache devices along the transmission path.

An aspect of some embodiments of the invention relates to content-free multicasting. In an exemplary embodiment of the invention, an index of what could be multicast is broadcast, without any actual content of what the index refers to, except, possibly, a sample. If a small number of receivers express interest in the content, the content may be unicast. If a large number of receivers express interest, the content may be actively multicast. In an exemplary embodiment of the invention, actively multicasting comprises modifying an already multicast stream to include data packets relating to the new content, together with an indication, for example in the index, of which multicast address includes the content of interest.

An aspect of some embodiments of the invention relates to differential decoding of multicast data. In an exemplary embodiment of the invention, a client can use side information, for example, previously received data, to decode only the information it is missing. In an exemplary embodiment of the invention, the number of packets required to be received is small, for example on the order of the data to be differentially decoded, possibly with a small overhead. In an exemplary embodiment of the invention, an index of which previously sent data can be considered side information, is provided. It is noted that at least in some embodiments of the invention, the multicast server does not need to know what side information is in the possession of the client, in order for differential decoding to operate.

It should be noted that differential decoding in accordance with some embodiments of the invention can utilize the partial overlap in time and partial overlap in content of Internet content pages and/or multicast information to allow faster retrieval of Internet content pages. In a particular example, a plurality of files are combined in a single content group and each receiver decodes only that part of the content group (e.g., those files) that it requires.

An aspect of some embodiments of the invention relates to operation in imperfect computer networks. Many computer networks do not support a robust multicasting protocol. As noted herein, in some embodiments of the invention, there is great flexibility with regard to the actual packets received. Thus, lost packets and bandwidth fluctuations need to be overcome.

Alternatively or additionally, in some embodiments of the invention, parts of the communication network (e.g., the Internet) are bridged using a “multicasting modem” pair. Such a modem pair is a software and/or hardware construct that includes a first, transmitter, modem for receiving a broadcast in a multicast-enabled part of a network and unicasting the broadcast over a non-multicast enabled part of the network to a, second, receiver modem. The second modem is also located in a multicast part of the network, where the broadcast is again multi-cast. Judicious use of multicasting modem pairs can also be used for allowing HTTP protocols over hybrid networks. In particular a satellite may be used as one of the multicasting modems, to bypass parts of a network where multicasting is not supported. Such a modem pair may be installed, for example, by a particular ISP, to allow more efficient transmission of data into and out of his local part of the network. Alternatively or additionally, such a modem pair may be used to provide relatively reliable communication using UDP, since the coding and transmission method corrects for missing and out of order data packets.

In an exemplary embodiment of the invention, such a modeming method may also be used to translate between different transport protocols (e.g., TCP and X.25), different higher-layer transport protocols (e.g., RTP, HTTP and FTP) and/or content protocols (e.g., AVI and Quicktime). In an exemplary embodiment of the invention, the content is changed to match different standardized formats in different networks. Alternatively or additionally, the content is changed to match geographical conventions, for example date format.

Alternatively or additionally, an information packet may also include routing programming instructions, so as to modify the transmission path of that packet on the Internet. In one example, a packet can include information requesting a particular router to use a particular path. In another example, the packet includes instructions for routers, in general, to use multicast enabled paths. In another example, such instructions can cause the formation of a multicasting modem pair. The network element affected by the instructions can be, for example, a router or a server. In another example, the packet includes a patch which may be used by a router to upgrade itself, to perform the requested function. Alternatively or additionally, a packet can include information not related to its priority, for example a flag that it contains data in a FEC format. Such information can assist in a reasoned decision on whether a router should to drop the packet, in case of congestion.

An aspect of some embodiments of the invention relates to bootstrapping the transmission of information. In an exemplary embodiment of the invention, the client which receives and decodes the multicast transmissions is written in a portable network language, such as Java. Thus, in some embodiments of the invention, a downloaded page includes code to execute a proxy locally. Optionally, the client is itself broadcast using some of the methods described herein. Optionally, a WWW page which belongs to a participating server can include a short Java script for downloading and installing the Java client. Alternatively or additionally, the Java client is embedded in the page or the page includes a link to a location from which the client can be retrieved. Several clients may be provided, each with different properties.

An aspect of some embodiments of the invention relates to providing a content location tool. Alternatively or additionally to resource name location tools, such as URLs, that indicate allow a particular location to be identified, a UCL (universal content locator) allows a particular content to be identified. In an exemplary embodiment of the invention, each content page that is multicast is assigned a substantially unique identifier, for example a hash of the page content and the time and date of creation, by the multicasting server. This identifier may be used, for example, when a client is instructed to use a particular previously transmitted content as side information for differential decoding. In some cases, a single UCL is used for several WWW pages that are pre-fetched together. Alternatively or additionally, this UCL is used when a user wants to retrieve certain information. The multicasting system (or other Internet service) can maintain a copy of all multicast information and its associated identifier. Alternatively or additionally, any Internet server can export a list of the content identifiers on the server. An Internet user can thus easily retrieve any content whose ID is known. A scheme similar to that of the “Napster” system can be used to support easy retrieval of the content. In some embodiments, a list of keywords or a short summary may also be associated with each unique ID.

An aspect of some embodiments of the invention relates to the generation of fake hits to a source server of WWW information that is being served by an Internet accelerator in a manner that precludes at least some contact with the source server by clients requesting information. The hits are typically used to track the profile of users that access the site and/or for other uses.

In an exemplary embodiment of the invention, the accelerator keeps track of at least some statistics regarding the downloading of information related to the source server. The statistics may be tracked by the Internet accelerator and/or by agent-portions of the acceleration system that reside on user's computers.

In an exemplary embodiment of the invention, the hits are provided as a statistics file to the server, possibly in a format used by hits-analysis programs. Alternatively, the hits are provided by contacting the server. Such contacting may be provided at times when the server is experiencing less traffic and/or may not request a significant amount of information.

Optionally, the statistics gathered include dwell times in pages and/or preferred link following strategies. In an exemplary embodiment of the invention, the actual identify of the users is hidden.

There is thus provided in accordance with an exemplary embodiment of the invention, a method of emulating an interactive connection, comprising:
generating a request for interactive data from an interactive server, at a client;
intercepting said request by an agent;
responsive to said request, retrieving at least some of said data from a continuous retransmission of said data, by said agent; and
displaying said data including said retrieved data at said client. Optionally, said agent emulates cookies for said client. Alternatively or additionally, said agent emulates an HTTP connection for said client.

In an exemplary embodiment of the invention, said agent is located at said client. Alternatively, said agent is located at a different site from said client.

In an exemplary embodiment of the invention, the method comprises continuously retransmitting files to create said stream. Optionally, the method comprises grouping files into content groups for the purpose of adding or removing groups from said continuous retransmission.

In an exemplary embodiment of the invention, said retransmission comprises a multicast retransmission. Alternatively or additionally, said retransmission comprises a unicast retransmission.

In an exemplary embodiment of the invention, said data in said retransmission is encoded using a FEC (forward error correction) code. Alternatively or additionally, retrieving comprises retrieving from a plurality of retransmission sources in parallel.

In an exemplary embodiment of the invention, the method comprises retrieving some of said data from said interactive server, in response to said request.

In an exemplary embodiment of the invention, the method comprises updating a content of said retransmission in response to said request.

In an exemplary embodiment of the invention, a content of said retransmission is independent of said request, during said retrieving.

In an exemplary embodiment of the invention, said displaying comprises personalized information for a particular user.

In an exemplary embodiment of the invention, the method comprises:
determining congestion by a network element along a path of said retransmission; and
reducing said congestion by unilateral dropping of packets by said network element. Optionally, said network element comprises a router.

In an exemplary embodiment of the invention, the method comprises determining by said agent a source for said data. Optionally, said determining comprises checking against an index. Alternatively or additionally, said determining comprises analyzing said request. Alternatively or additionally, said determining comprises querying a file distribution server.

In an exemplary embodiment of the invention, said data is retrieved from a multi-layer stream. Optionally, said agent selects which layers to be used for retrieval responsive to available bandwidth.

In an exemplary embodiment of the invention, said agent stores locally at least some data and wherein said agent downloads only enough data as needed for reconstructing said data in view of the locally stored data.

There is thus provided in accordance with an exemplary embodiment of the invention, a method of transmitting a plurality of files, comprising:
combining said files into a content group, at a content combiner;
encoding said content group using a FEC (forward error correction code); and
continuously retransmitting said encoded files. Optionally, the method comprises stopping said retransmission if fewer than a certain number of receivers are listening to said transmission. Optionally, the method comprises continuing to transmit at least some of said encoded files to said listening receivers, using a different transmission method than used for said continuously retransmitting.

In an exemplary embodiment of the invention, the method comprises:
retrieving said encoded content group by an agent program; and
converting said encoded content group into files, for use by a file oriented target program. Optionally, said agent emulates an interactive connection for a user of said target program using said file. Alternatively or additionally, said combining comprises combining responsive to statistics gathered by said agent. Optionally, the method comprises generating hit statistics for content sources based on said statistics. Optionally, the method comprises transmitting said hit statistics to operators of said content sources.

In an exemplary embodiment of the invention, the method comprises transmitting at least a part of said agent as a part of a content group. Optionally, a bootstrap part of said agent is transmitted in a preferential manner over other parts of said agent.

In an exemplary embodiment of the invention, the method comprises transmitting update information, for differential decoding relative to previously received content groups.

In an exemplary embodiment of the invention, the method comprises said update information comprises replacement files.

In an exemplary embodiment of the invention, said update information comprises software updates.

In an exemplary embodiment of the invention, the method comprises transmitting an index of content groups and locations where said content groups are available for retrieval. Optionally, at least a part of said index is encoded in a preferential manner so that that part is preferentially received before other parts of said index.

There is thus provided in accordance with an exemplary embodiment of the invention, a method of locating information on an Internet, comprising:
providing a content locator for the information, said content locator being defined as a hash function of said information; and
searching for data having a content locator matching said content locator in a plurality of Internet sites having unrelated owners. Optionally, the method comprises analyzing said information to determine if it matches said content locator. Alternatively or additionally, the method comprises generating a content locator for new data prior to the data being broadcast. Alternatively or additionally, searching comprises searching in an index that matches content locators and storage locations.

There is thus provided in accordance with an exemplary embodiment of the invention, a method of reliable UDP transmission of a data file, comprising;
encoding said data file using FEC (forward error correction) encoding into a plurality of packets;
transmitting said packets using a UDP protocol. Optionally, said encoding comprises continuously generating new packets for said stream, independent of a length of said data file.

There is thus provided in accordance with an exemplary embodiment of the invention, a method of emulating multicasting, comprising:
determining by a multicasting server a list of clients desiring a multicast transmission;
generating a stream of packets for said transmission;
duplicating said packet stream; and
unicasting said packets to said clients. Optionally, duplicating comprises duplicating using a zero socket duplication method.

There is thus provided in accordance with an exemplary embodiment of the invention, a method of file transmission, comprising:
collecting request statistics for at least two files;
determining that requests for at least two files by a plurality of users are correlated part of the time but not all of the time;
grouping said two files into a group; and
continuously retransmitting said group by multicasting. Optionally, said determining comprises determining according to geographical origins of said requests.

There is thus provided in accordance with an exemplary embodiment of the invention, a method of reduced multicasting, comprising:
announcing the existence of a multicasting location;
listening for requests to connect to the multicasting location; and
building a multicasting tree on a host of said multicasting location only in response to a request to connect. Optionally, the method comprises stopping transmission of content on said tree when a count of requesters reaches zero.

There is thus provided in accordance with an exemplary embodiment of the invention, a method of multicasting a plurality of channels, comprising:
multicasting a plurality of channels, each channel having a respective content; and
multicasting an index channel listing at least an identification of said channels and an indication of their respective content. Optionally, said index includes an indication of a geographical region served by said channel.

There is thus provided in accordance with an exemplary embodiment of the invention, a method of multicasting over an Internet, comprising:
generating a multicast transmission at a first location;
converting said multicasting transmission into a unicast transmission at a second location, for transmission to a third location over a part of said Internet that does not support multi casting;
converting said unicast transmission into a multicast transmission at said third location. Optionally, the method comprises transmitting said transmission using unicast transmission to a plurality of clients in said part of said Internet. Alternatively or additionally, a transmission from said first part to said second part is by a satellite.

There is thus provided in accordance with an exemplary embodiment of the invention, an interactive file transmission accelerator, comprising:
a file encoder that encoding a plurality of files using an FEC code, into encoded packets;
a broadcast transmitter that transmits said packets in a non-personalized transmission; and
an agent receiver associated with a user operative to emulate, to a user, an interactive connection to a file source of said files. Optionally, said broadcast transmitter comprises a multicast transmitter. Alternatively or additionally, said broadcast transmitter comprises a multiple unicast transmitter that sends a same unicast transmission to a plurality of agent receivers.

In an exemplary embodiment of the invention, said file source is at a different site from said file encoder. Optionally, said file source is connected to said file encoder by an Internet.

In an exemplary embodiment of the invention, the accelerator comprises a user computer, wherein said user computer is at a different site from said agent receiver. Optionally, said agent is connected to said user computer via an Internet.

In an exemplary embodiment of the invention, the accelerator comprises at least one cache for packets on an Internet path interconnecting said transmitter and said agent.

In an exemplary embodiment of the invention, the accelerator comprises at least re-broadcasting station on an Internet path interconnecting said transmitter and said agent, for local broadcasting of said packets. In an exemplary embodiment of the invention, the accelerator comprises a plurality of reception agents for different users, each of said reception agents having a different reception bandwidth for said transmission.

There is thus provided in accordance with an exemplary embodiment of the invention, a method of broadcasting non-computer media information, comprising:
encoding a media file into encoded data, using a FEC code;
broadcasting said encoded data;
receiving said encoded data by a plurality of receivers; and
reconstructing said media at said plurality of receivers. Optionally, each of said receivers has a different data reception rate. Alternatively or additionally, each of said receivers has a noise rate for said transmission. Alternatively or additionally, broadcasting comprises broadcasting by radio. Alternatively or additionally, broadcasting comprises broadcasting by cable TV. Alternatively or additionally, broadcasting comprises broadcasting by satellite. Alternatively or additionally, encoding comprises encoding into packets.

### BRIEF DESCRIPTION OF THE FIGURES

Non-limiting exemplary embodiments of the invention will be described in following description of exemplary embodiments, read in conjunction with the accompanying figures. Identical structures, elements or parts that appear in more than one of the figures are labeled with a same or similar numeral in all the figures in which they appear.

FIG. 1 is a schematic block diagram of an interactive data transmission configuration, in accordance with an exemplary embodiment of the invention;

FIG. 2 is a schematic illustration showing various possible locations for a data transfer agent, in accordance with preferred embodiments of the invention;

FIG. 3 is a block diagram of an exemplary interactive data transmission configuration, in accordance with an exemplary embodiment of the invention;

FIG. 4 is a flowchart of a typical WWW interaction by a user;

FIG. 5 is a flowchart of an exemplary course of action by an agent, in response to the interaction of FIG. 4, in accordance with an exemplary embodiment of the invention;

FIG. 6 is a flowchart of an exemplary course of action by a multicasting server, in response to the interaction of FIG. 4, in accordance with an exemplary embodiment of the invention;

FIG. 7 is a flowchart of a channel life process, in accordance with an exemplary embodiment of the invention; and

FIG. 8 shows a method of multi-cast modeming, in which multi-cast-enabled domains of the Internet are connected using modem like servers, in accordance with an exemplary embodiment of the invention.

### DETAILED DESCRIPTION OF SOME EMBODIMENTS OF THE INVENTION SYSTEM OVERVIEW

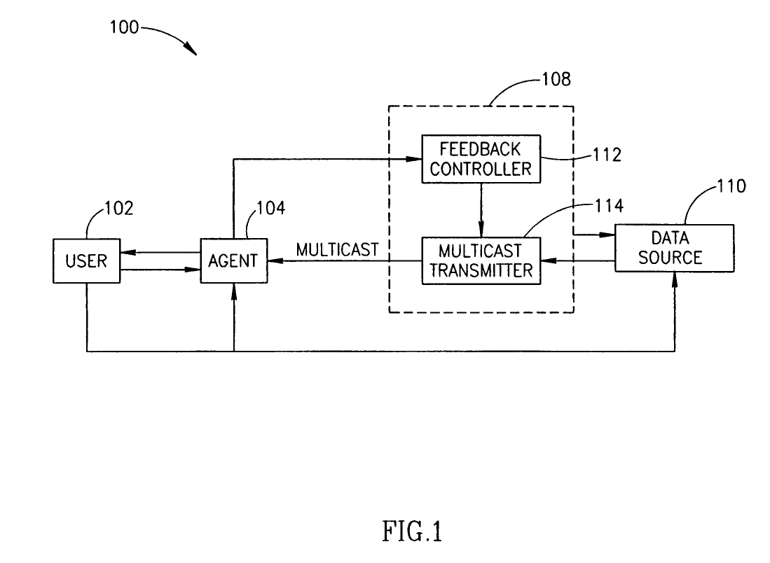

FIG. 1 is a schematic block diagram of an interactive data transmission configuration 100, in accordance with an exemplary embodiment of the invention, in which a user 102 receives content from a data source 110. In an exemplary embodiment of the invention, data source 110 is a WWW server sending WWW pages to user 102 using a HTTP protocol. Alternatively or additionally, other communication networks may be used, for example, cellular networks, dedicated computer networks, cable TV and/or satellite networks. Alternatively or additionally, other transmission protocols may be supported, for example RTP.

In an exemplary embodiment of the invention, server 108 comprises a multicast transmitter 114 which broadcast the content to a plurality of users, including user 102. Optionally, but not necessarily, server 108 is separate from data source 110. An agent 104, optionally associated with one or more users 102, receives the multicast broadcast and converts it to a format understandable by the receiving equipment used by user 102. Alternatively or additionally, agent 104 assists in emulating an interactive connection between user 102 and data source 110, over the multicast channel.

In an exemplary embodiment of the invention, the content is transmitted as packets, which may be encoded, for example as described below. Alternatively, the content is transmitted as a bit stream, with no discrete packets.

In an exemplary embodiment of the invention, server 108 comprises a feedback controller 112 that modifies the content of the multicast broadcast, responsive to the users' requests. Such request and/or other feedback may be provided, for example by agent 104 and/or determined by server 308 analyzing transmission statistics.

Deployment Possibilities

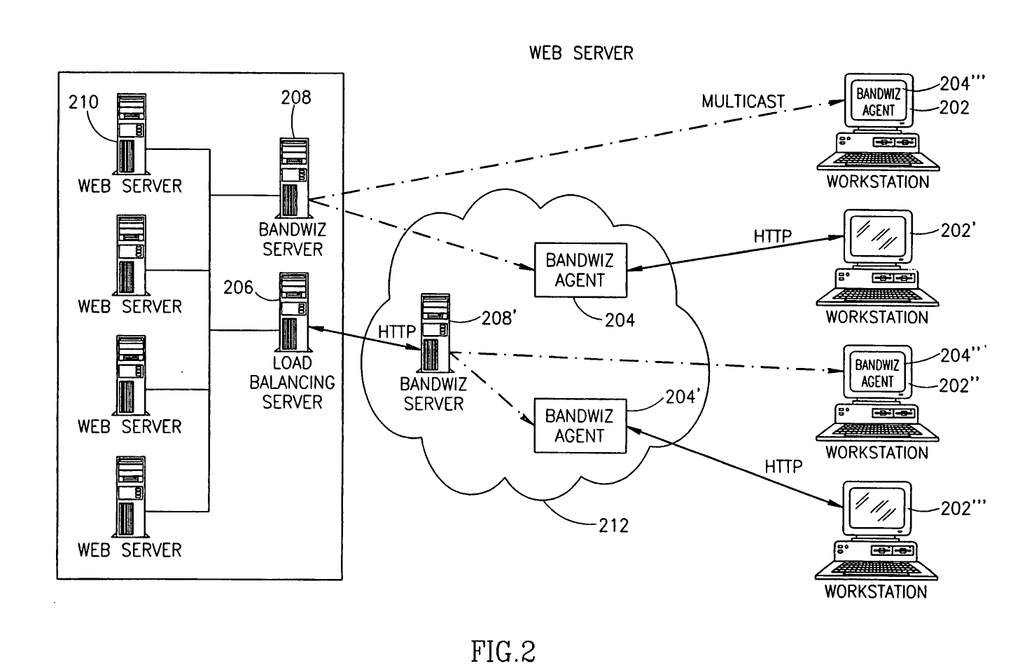

FIG. 2 is a schematic illustration showing various possible locations for a data transfer agent, in accordance with preferred embodiments of the invention. Four different general schemes are shown in FIG. 2, and variations thereon are also possible. Multicasting is indicated by a dotted line, HTTP and other point-to-point connections, by a solid line.

In a first scheme, a web server installation comprises a plurality of server computer 210. A server 208, connected to servers 210, for example by a LAN, MAN (Local and Metropolitan Area Network) multicasts the data over an Internet 212 to an agent 204′″, executing on a user terminal 202.

In a second scheme, an agent 204 is located in Internet 212. Agent 204 receives a multicast broadcast of the data and unicasts the data, for example as HTTP to a user terminal 202′.

In a third scheme, a server 208′ is also located in the Internet. Optionally, a load balancing server 206 is provided between web servers 210 and multicasting server 208′, for example to decide which server 208′ to use, if any. An agent 204″ is executing on or near a user terminal 202″.

In a fourth scheme, both Internet multicasting server 208′ and a user agent 204′ are on an Internet, and agent 204′ communicates with a user terminal 202′″.

It is noted that the agent may be connected by LAN to the user terminal. Alternatively, it may execute on the same computer, as a separate program. Alternatively, it may execute as part of the browser, for example as a plug-in or as a Java applet. In an exemplary embodiment of the invention, the multicast decoding agent is integrated with the browser, to allow the browser to perform various transmission-related activities, for example progressive display of images in standard formats, as multicasting data arrives. Another exemplary application is more efficient updating of changes in a display, when display updates arrive. It should also be noted that an Intranet, Extranet or other type of data network may be provided instead of an Internet in the above described.

Detailed Exemplary System Design

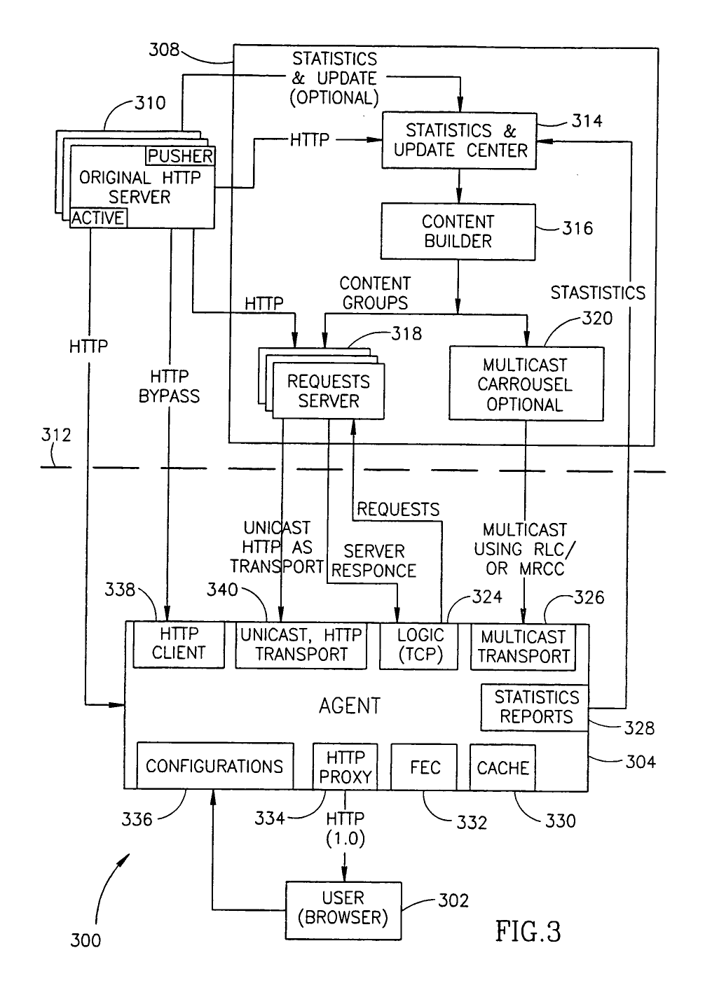

FIG. 3 is a block diagram of an exemplary interactive data transmission configuration 300, in accordance with an exemplary embodiment of the invention.

An original HTTP server 310 and a user browser 302 are mediated between by multicasting server 308. Reference 312 represents an Internet. However, as noted above, various configurations may be practiced and some of the blocks shown in FIG. 3 may be omitted and/or otherwise configured.

In an exemplary embodiment of the invention, server 308 comprises a statistics server 314, which receives various usage statistics from parts of configuration 300 (e.g., server 310, user 302, agent 304 such as via a statistics reports module 328 and parts of server 308) and uses the information to drive a content builder 316, which puts together information to be transmitted as content groups (optional and described below). A requests server 318 handles requests from agent(s) 304 and/or server 310, for example, by sending content groups and/or emulating user 302 and/or server 310. Optionally, the content groups are transmitted by multicasting, for example using a multicasting carrousel 320. Alternatively, they are transmitted by unicasting or by HTTP, for example in parts of the Internet where multicasting is not available.

Various communication options are illustrated in FIG. 3. Server 310 may send the content to server 308, for content builder 316 and/or to requests server 318, for dissemination. Alternatively or additionally, server 310 may send the content to agent 304, for passing on to user 302. Alternatively or additionally, server 310 may send the content to a HTTP client 338 on agent 304. As will be explained below, the different methods of providing content from server 310 to user 302 may assist in partial or complete bypassing of server 308. Server 308 can send content to agent 304 in many ways, for example as multicasting data to a multicast receiver 326 and/or as unicast or HTTP data to a unicast port 340. A logic element 324 of agent 304 may handle various commands and status reports vis-à-vis requests server 318. Agent 304 may also include a cache 330 (e.g., to decrease repeated downloading of same content) and a forward error correction mechanism 332 (described below). Typically, multiple agents 304 are provided, for different clients 302, as will be described below. A plurality of agents 304 may be connected to one or more servers 308, also described below. Different ones of the agents may have different capabilities.

In an exemplary embodiment of the invention, agent 304 communicates with client 302 via an HTTP proxy 334, or is integrated therewith. Alternatively or additionally, agent 304 may load various user configuration setting and/or be programmed by user 302, via a configuration port 336.

Flowcharts of Exemplary Typical Interaction

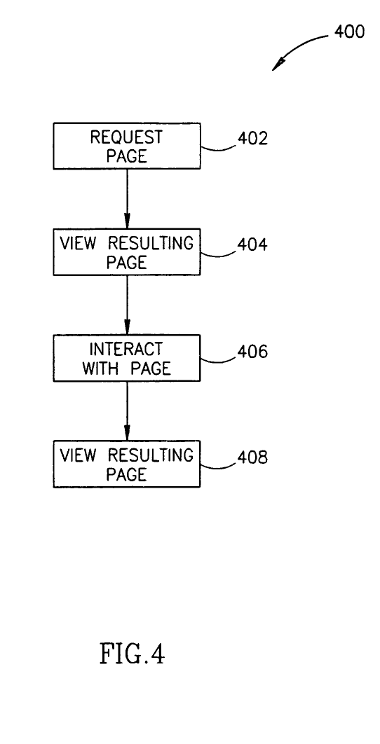

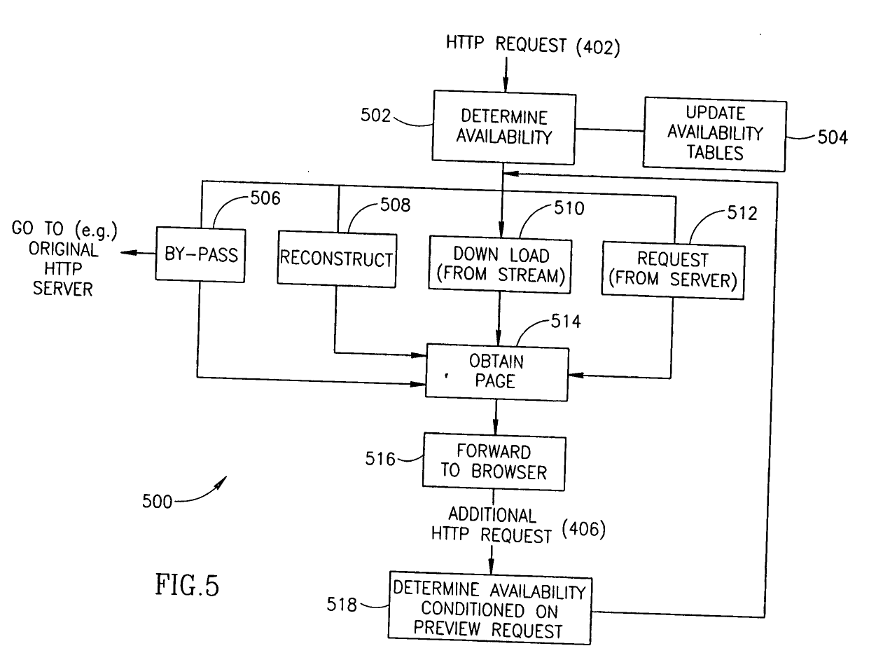

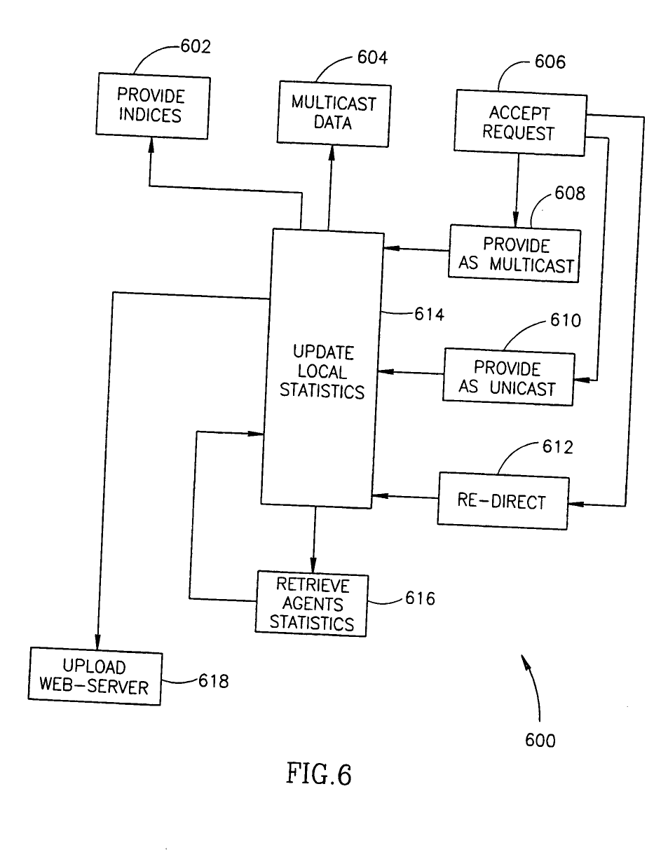

FIG. 4 is a flowchart 400 of a typical WWW interaction by a user. FIG. 5 is a flowchart 500 of an exemplary course of action by an agent 304, in response to the interaction of FIG. 4, in accordance with an exemplary embodiment of the invention. FIG. 6 is a flowchart 600 of an exemplary course of action by a multicasting server 308, in response to the interaction of FIG. 4, in accordance with an exemplary embodiment of the invention.

A user (or automated program) requests to view a page (402). Typically, this request is in HTTP form, however, other request types (e.g., for the data or for resources such as streaming video) may also be generally supported by the system. A page is typically composed of several URLs, each of which typically represents a file. The URLs are typically requested by user browser 302 in sequence. For each request, agent 304 determines the availability of the URL (502). Four basic types of availability are shown in FIG. 5: by-passing the system (506), reconstructing from previously acquired packets (508), downloading from a multicast stream (510) and requesting the URL from server 308 (512). The availability may be determined, for example using tables, rules and/or interaction with server 308 or original HTTP server 310, as described below. Various method of updating such tables and rules (504) are also described below.

At 506, the HTTP request bypasses the system, for example, for a cgi/bin request, for non-HTTP resources, such as RTP or RTSP requests or other remote protocols, for example remote procedure call, or for pages which are indexed as not being supported. The request may be forwarded to the original HTTP server to which the request was directed and the reply may be handled by the system (514, below) or it may go directly to browser 302. In another example, a Java applet (or other network programmable module) that is executed on browser 302, may connect to its server using the bypass mechanism. Optionally, an attempt to respond to the Java applet using one of the other information obtaining methods (508, 510 and/or 512) may be used. Alternatively or additionally, these methods may be used with non-HTTP protocols, such as RTCP and FTP.

Optionally, the indexes at 504 include an indication of an alternate, non-original address, for retrieving the resource, for example an alternate server (e.g., mirroring), a cache (such as Akamai) or a temporary location (e.g., an on-line computer as in Napster).

In an exemplary embodiment of the invention, the indexes (and a behavior of agent 304 as a transparent proxy) are used to redirect any request to a server, as desired. In one example, this redirection is for load balancing. Alternatively or additionally, this reduction is for preferring commercial partners.

At 508, data for the page is already available at agent 304, and is used to reconstruct the requested file. The data may, for example, have been previously received and unused, previously received and decoded and/or cached.

At 510, the data is not available at agent 304, but it is available from a multi-cast (or unicast) stream. Agent 304 may be required to connect to the stream to download the data. Optionally, instead of a multicasting server 320, the data for multicasting is forwarded to a UDP distributor (not shown), which is copied, for example, using a zero-copy socket method, and sent by UDP or other cheap, less reliable method, to all agents 302 that request the data. Various indexes may be provided (504), that include addresses for downloading the data using UDP. Other parts of system 300 may also perform zero-copying and then forwarding.

At 512, the data is not locally available and is not earmarked for bypass. A request for the data is sent to server 308, as detailed in FIG. 6. In some cases, the server refuses the request (e.g., if it is overloaded or if the request cannot be answered) and the request by-passes (506) the system.

At 514, the page (or individual files) is generated and forwarded to the browser (516). In some cases, a single retrieved file may be reconstructed from data available from several of the above methods, for example, two packets describing the file may be available locally (508), while two more may need to be downloaded (510).

Once the page is displayed, (404), a user may interact with the page (406), for example, pressing a control and/or entering data. This typically generates another HTTP request (or a request in another protocol), to update the display, which HTTP request may request an unrelated page or a related, possibly similar, page (displayed at 408). At 518, agent 304 can optionally determine the availability of such a page, based, for example, on the identification of a correspondence between the previous and current request.

Example of Viewing a Compound and Personalized Page

In an exemplary application, server 310 is a server for a news website. The main page at the web site is a compound page, comprising a main file that describes the page and a plurality of files that describe embedded objects, for example, images. In an exemplary embodiment of the invention, server 308 connects to the news website and retrieves all the files in the main page (and also possibly in other pages). When a user connects to the news website server, requesting to view the main page, the request is intercepted by agent 304 or forwarded to agent 304 by the CNN web site or an intermediate proxy. As described above in FIG. 5, all available files are provided by agent 304 to user 302. When the user requests another page, if those files are available they are provided to the user.

A particular case where some constituent files are not available is when the user views a personalized version of the page. In such pages, the main file of the page is typically personalized, however, many or all of the constituent files are not, instead, the personalization is typically exhibited as a personal selecting between available files. Thus, the personalized page is not provided by server 308, but by the server. The individual image and/or other content files, however, can be provided by server 308. The browser at user 302 decides which files to request, based on the description in the master file. In an exemplary embodiment of the invention, the personalized pages have a URL that matches a pattern of personalized pages, for example including the phrase “username=” in them. In an exemplary embodiment of the invention, the index and/or rules updated in 504, contain a pattern that matches the personalized pages, thus, agent 304 (and/or server 308) can determine if the page should be retrieved via the system or bypassed to the original server (310). As will be described below with respect to content groups, in some embodiments of the invention, the embedded files of a particular page may be provided in a single content group.

In an alternative embodiment, server 308 and/or agent 304 may perform the logging-in to the personal page, instead of the user.

When a user enters input to a page, that input can be forwarded to the server. Typically, the response of the server is a personalized main file, and standard (e.g., repeating) embedded files. The main page will be provided by server 310, while the embedded files by server 308. In some embodiments of the invention, all main pages are provided by the server, and only embedded files are provided by server 308. In an exemplary embodiment of the invention, server 308 determines ahead of time (or is provided with the information) which files are main files (which are more often provided by server 310) and which files are embedded (and are more often provided by server 308). In an exemplary embodiment of the invention, the server performs the determination by tracking which pages are marked by server 310 as being volatile.

In an exemplary embodiment of the invention, agent 304 can know ahead of time which files are main file and which are embedded. In an exemplary embodiment of the invention, the agent retains a logging of the file provider, for WWW sites frequented by user 302. The identification of the page source may be used by the agent to determine where to requests a page from or it may be forwarded to server 308. Server 308 may aggregate this information from a plurality of agents, to build a database. Alternatively or additionally, this information may be provided periodically or on request to the agent.

In some embodiments of the invention, agent 304 will form at least a cursory connection with server 310, so that server 310 can retrieve cookies from the user's computer, for personalization of the page. Alternatively or additionally, agent 304 may retrieve the cookies and pass them to server 310, so server 310 can prepare the personalized main page.

Availability Determination

Referring back to FIG. 5, at 502, the availability of a page is determined. At 504, a process of updating various tables or other data structures used to assist in the determination process, is optionally performed.

The availability of a file can depend, for example, on one or more of:
(a) file hit rate;
(b) desired response time (typically paid for by page publisher)
(c) file publisher;
(d) file storage location;
(e) time of day or date (especially for pages whose hit rate depends on time or date);
(f) instantaneous load on system (which may refuse connections);
(g) general load on system and/or communication channels;
(h) file staleness;
(i) file type (e.g., text, image);
(j) file size; and/or
(k) file commonality (e.g., how personalized is it).

The file availability can vary dynamically, for example, with files being moved from one availability channel to another as needs and/or resources change. In some files, however, the availability method is fixed, for example, in some embodiments login pages may always be provided using bypass methods.

Availability determination may remote, for example, by agent 304 querying server 308 or an intermediate proxy server for the availability of a file. In an exemplary embodiment of the invention, a hierarchy is defined, with agent 304 being sent up the hierarchy by the members of the hierarchy and/or by the content indexes indicating which member of the hierarchy to contact for certain files.

Alternatively or additionally, agent 304 maintains local data structures, which can be used to determine availability. These data structures may use any of the above attributes and/or additional attributes, such as URL format and file name.

In an exemplary embodiment of the invention, the data structures may comprise one or more of:
(a) a table of URLs or file names, with associated availability indicators;
(b) a table of patterns for matching URLs, with associated availability indicators; and/or
(c) rules for determining availability based on a file, based on other files in a page and/or based on previously received and/or requested files. In some cases, the rules will also define an action, for example, providing a usage statistic to server 308.

Various defaults may be defined for unmatched requests, for example, automatically bypassing if no match is found.

Referring in particular to 504, updating, updating may take many forms, for example, the tables and/or other data structures may be continuously broadcast or unicast to agent 304. Alternatively or additionally, a periodic update is provided. Alternatively or additionally, agent 304 requests an update, for example when logging on and/or periodically. Different rules and/or records in the table may be updated at different rates. Alternatively or additionally, the rules may use various statistics, for example, page update statistics that are themselves updated. Alternatively or additionally, server 310 may send a message indicating the availability method. The update method and/or the availability options may also depend on cost considerations, for example, a payment scheme to which the user subscribes.

The availability indication may act only as a recommendation, for example, if server 308 refuses to provide a response to a request, agent 304 may be forced to bypass, to prevent an undesirable degradation in service.

Alternatively or additionally to system mandated availability indications, a user can request and/or override the system settings. In one example, a user can request that a certain page always be acquired by bypass. Alternatively or additionally, a user can define his personal settings and/or rules. Alternatively or additionally, a user can accept system-suggested settings, even if they prevent the user from receiving a personalized version of a WWW page or other service.

In an exemplary embodiment of the invention, rules for fallback situations are defined in agent 304 and/or server 308, to deal with situations where server 308 does not answer and/or where downloading from a content stream does not work. In one example, the fallback is to contact server 310. Alternatively, low rate, more dependable content streams may be provided. Alternatively or additionally, unicasting by a unicasting server may be provided. Alternatively or additionally, unencoded data packets may be available, for example from a backup stream or a backup server.

In an exemplary embodiment of the invention, the downloading of the index may take a non-trivial amount of time. As a result, agent 304 may be allowed to contact server 310 and/or 308 directly, without cost penalty, until the index is downloaded. Alternatively or additionally, the beginning of the index (possibly preferentially encoded as described below) includes general ground rules for downloading, for example, lists of sites or domains that are not supported. Possibly, a later part of the directory includes revisions to these general rules, for example a supported part of a site that is generally unsupported.

Alternatively or additionally, when agent 304 contacts server 308 with a request, the server responds with a part of the index that contains rules for the sites most likely to be later requested by agent 304, for example, based on a personalized Internet accessing profile or based on a general statistical aggregation profile.

Downloading from a Stream

As noted above (510), in some cases, some or all of the data required by agent 304 for user 302 is available in one or more multicast streams. Agent 304 may already be connected to the streams in which the data is available. In such a case, the agent will acquire packets until the data can be reconstructed from the acquired packets.

Alternatively, agent 304 may be required to connect to a stream that is broadcasting the data. The identity of the stream may be provided by server 308, in response to a request by agent 304 (512). In some cases, server 308 will create a new stream, in response to an identification of agent data needs.

Alternatively, agent 304 may use a stream index (or search engine) to determine which stream includes the required information. In an exemplary embodiment of the invention, a universal content locator code (described below) is used to identify the contents of each stream. This will be described in greater detail below. The index may be, for example, stored at agent 304, available form a proxy, be multicast and/or available from server 308, it may be updated, for example, as described above for availability indexes 504. In an exemplary embodiment of the invention, the two indexes are a same index, including not only an availability type, but also an availability location.

Support of Pre-SSM (PIM-SM) and Post-SSM (PIM-SSM) Multicasting

Configuration 300 can support one or both of pre-SSM multicasting and post-SSM multicasting. In pre-SSM multicasting, agent 304 provides the nearest router with a rendezvous point address, provided by an index or server 308.

In SSM multicasting, multicast carousel 320 (or a suitable proxy) can serve as the base of the multicasting tree. This represents a clear, single, sender, in compliance with the SSM protocol. So, a request to join a multicasting stream can also include the address of the multicasting server (or proxy) from which data is to be received by agent 304.

Virtual Multicasting

In an exemplary embodiment of the invention, multicasting channels are set up, but little or no actual content is transmitted therein, so that less real bandwidth is required. When agent 304 connects to the channel, server 308 is notified. This notification may be part of the multicasting protocol (not currently implemented) or it may be a separate notification, for example, by UDP or TCP/IP connection, and starts sending real content in the stream. In an exemplary embodiment of the invention, the routers in the router hierarchy for the multicasting are notified of the possibility of data sending, so they store a state, even though there may be no actual data being transmitted.

Alternatively or additionally, no real channels are set up. Instead a published index includes mapping of content to channels, when an agent expresses interest in a channel (e.g., to server 308), the channel is created and/or transmission starts.

Unicast Broadcasting Emulation

In an exemplary embodiment of the invention, multicasting carousel 320 transmits at least some channels by unicasting, rather than multicasting. Efficient unicasting can make use of a zero-copy socket (or its equivalent) available in many operating systems. This socket allows fast copying of data packets.

In an exemplary embodiment of the invention, carousel 320 is split into two parts, one part that prepares the information for broadcast, and another part that selectively transmits the information by unicasting (preferably using UDP) or multicasting. The type of actual transmission method used, may depend, for example, on available bandwidth, available multicasting channels, desired service quality and/or on the type of multicasting service available at client 302.

In an alternative embodiment a plurality of acceleration servers are provided, for providing the unicast data to users. These servers may be distributed in the Internet and/or may be hierarchically organized.

In an exemplary embodiment of the invention, a single agent 304 may receive data from multiple senders, for example one or more unicast servers and/or one or more multicast servers. Multiple reception may be useful, for example, to overcome congestion in any one route. In an exemplary embodiment of the invention, where data is transmitted in packets generated using a seed-based randomization function, different seeds are used for different servers, so that there is less likelihood of overlap between different received sets of packets. Optionally, each such stream sends its seed, for example, periodically. Alternatively, a mapping of seeds to servers is multicast or available on request.

Server Response

Referring to FIG. 6, server 308 receives a request for data (606), for example, if the availability method is “from server” or if no availability method is known. At 608, the request is supplied via multicasting, either by indicating an existing multicasting address, or by creating a new multicasting channel. Multicasting in this respect also includes unicasting broadcast emulation. At 610, the data is provided by unicast from server 308, or from a proxy thereof. At 612, the request for data is redirected to another server, for example to original WWW server 310.

Any of these actions and/or the requests itself may be used to update various statistics stored at server 308 (614). One possible effect of these statistics is modifying the content and/or existence of multicasting channels and/or data requests and/or clients handled by server 308 (604).

Another possible effect is updating indexes (602), for use in process 504.

Another possible effect is uploading statistics to original WWW server 310 (618). For example, a server may be updated with the number, temporal distribution and/or geographical profile of users. In an exemplary embodiment of the invention, server 308 periodically generates a set of hits for server 310, so that the server can be appraised of the “real” traffic through the site, using the sites existing profiling tools. In an exemplary embodiment of the invention, these hits are generated at times when the server traffic is low. Alternatively or additionally, the hits are provided as a file to be assimilated by the server's profiling tools.

Alternatively or additionally to local statistical update, (616) usage and/or request statistics may be reported by a plurality of agents 304. Alternatively or additionally, the statistics may be reported to the agents, for example for use in pre-fetching (described below). Alternatively or additionally, the statistics are compared to those acquired by server 310 at different times or via users not connected to the system. Possibly, some requests are intentionally redirected to server 310, to test the responsiveness of server 310 and/or to generate independent statistics. Such testing may be performed, for example, by server 308, or by a third party.

File Aggregation

The contents of a multicast channel may be a single file. In some embodiments of the invention, however, a channel contains a plurality of files. The files in a channel may be related, for example, belonging to a same page or site. Alternatively or additionally, the files combined in a single channel reflect files that are likely to be viewed by a group of users. Possibly, the channel is designed for a particular group of users, for example, a geographically near group, or a group with a shared router. Alternatively, the “group” is generated ad hoc. Alternatively or additionally, the files are combined based on temporal coincidence in their expected viewing. Alternatively or additionally, the files are combined based on the files being related, for example, expiring at a same time, being embedded in a same web page, belonging to a same web site, being connected by a link and/or being audio and video or multiple audio tracks (e.g., different languages) of a same media content. Alternatively or additionally, the combination is related to performance, for example, being based on file size, on update rate, and/or on required response time (from the server). Alternatively or additionally, the files combinations may be optimized, for example, for cost or for ease of billing.

In an exemplary embodiment of the invention, the multiple files in a single group are encoded as if they were a single file. As will be explained below, such an encoding potentially allows any part of the group to be reconstructed if the rest of the group is known and a minimum number of packets is received. There is no need to wait until the end of a data carousel. Alternatively or additionally, such grouping potentially reduces the overhead, for example, in terms of number of files to be tracked, in number of channels for an agent to subscribe to and/or in number of ongoing reconstruction at the agent.

Although the multicast channels may be made non-overlapping, in some embodiments of the invention, there is overlap in channel content between different multicast channels. In an exemplary embodiment of the invention, the overlap is caused by a desire to reduce the rate of channel switching. In some cases, the packet transmission rate for a particular file, may be different in different channels, for example there being a main channel for the file, and a secondary channel in which the file is an additional broadcast file. Such overlap may also allow some robustness in the system, as the failure of a single multicasting channel need not be catastrophic.

Various statistical methods may be applied towards determining desired combinations of files in a channel, for example, based on actual performance reported by agents, and/or based on requests by agents.

Combined Unicasting and Multicasting

The considerations for deciding what to group and/or what to combine in a single channel may also be applied towards deciding if a channel, group or file is to be unicast or multicast. In addition, for any particular site, it is expected that most pages are not popular and thus may be unicast. The small number of popular pages may be multicast, as individuals or as a group. Possibly, agent 304 requests some files by unicast, while retrieving other files being received by multicast. Alternatively or additionally, some parts of a file are received by unicast and some by multicast, for example, if the multicasting is started after unicast transmission of the file started, or if the unicasting is used to finish up the reception of a file by an agent, after multicasting of the file is stopped. Alternatively or additionally, unicasting may be used for personalized embedded files, for example for personalized advertisements in a generally multicast WWW page.

Alternatively or additionally, unicasting is used in a data carousel, if the expected delay to wait for a packet is too long. Alternatively or additionally, unicasting may be used if the set-up time is considerably shorted than for multicasting and/or if the bandwidth of the unicast channel is considerably greater.

In an exemplary embodiment of the invention, the following decision formula is used to decide if to send a file by multicasting or by unicasting. In an exemplary embodiment of the invention, use is made of the non-symmetric distribution (typically Poisson) of requests for files:

if λS>W then multicast, where λ is the request rate for the file (e.g. requests per second), S is the file size (e.g., bytes) and W is the bandwidth allocated for multicasting the file (e.g., bytes/sec).

In an exemplary embodiment of the invention, the bandwidth allocated for multicasting a file is determined based on the allowed delay in receiving the file and/or the file size. The following formula inter-relates the minimal delay, L, possible in the system, the file size, S, and the allocated bandwidth, W: L=S/W.

Pre-Fetching

In some embodiments of the invention, agent 304 fetches and records extra packets from the multicast channels, in anticipation of user request. The suggestion of files for which to record packets, may be provided, for example by server 308. Alternatively or additionally, it may be determined from a profile of user 302, for example at agent 304.

Pre-fetching may be at the level of data. Alternatively, an agent 304 may pre-fetch (and store) cross-buckets.

Pre-fetching may be used instead of or in addition to file aggregation. Alternatively or additionally, groups may be aggregated to form macro-groups, for example such a macro-group being defined based on personal WWW browsing statistics.

In an exemplary embodiment of the invention, in a pre-fetching process, all the resources required for showing a page are pre-fetched.

Data Arrangement and Content Groups

Alternatively or additionally to pre-fetching, server 308 may arrange the data in a manner that agents 304 are likely to find required data on a same stream or multicasting channel as already being received and/or in previously received packets. This data arrangement can be driven, for example, by statistics 614, or by statistics provided by server 310. Optionally, as time goes on, server 308 updates the usage statistics and/or profiles of particular users or groups of users. Possibly, users are grouped automatically based on their profiles.

In an exemplary embodiment of the invention, agents 304 send statistics and/or other anonymous aggregations of information, to allow the discovery and/or support of communities, for example by providing raw data from which community profiles may be constructed. Such statistics may be used, for example, for one or more of, geographical distribution of channels, groups and files, data aggregation (e.g., for groups, channels, meta-groups and/or pre-fetching), transmission duration and/or transmission times (e.g., channel programming and/or transmission windows in general.

Feedback Between Server and Agent

In some embodiments of the invention, agents 304 can provide various types of feedback to server 308, resulting, for example, in modifying and/or optimizing its behavior.

Exemplary feedback, includes one or more of:
(a) page hit rate;
(b) time to switch between pages;
(c) noise level and packet losses, for example for changing the ratio of cross-bucket packets to regular packets (described below);
(d) user profile; and/or
(e) page viewing order.

The feedback may be provided as records of individual cases and/or aggregated as statistics, for example, average, variance and distribution function.

Alternatively or additionally, feedback may be provided from server 308 to agent 304, for example, the number of times the answer to a request was already found in a broadcasting channel. This can drive agent 304 to update its local indexes.

Alternatively or additionally, feedback may be provided between agents 304, for example, server 308 updating one agent with “discoveries” regarding suitable pre-fetching behavior. Optionally, server 308 processes data from many agents before reporting the results to the agents.

Multiple User Implementation

In a typical implementation, configuration 300 is designed to serve multiple clients 302. In an exemplary embodiment of the invention, configuration 300 includes a plurality of agents 304, all connected to a same server 308. Alternatively or additionally, configuration 300 may include a plurality of servers 308.

In some implementations, some of servers 308 are associated with particular servers 310. Alternatively or additionally, some servers are geographically placed, to server a client base and/or a server base. Alternatively or additionally, some servers are general.

In some embodiments of the invention, server 308 is split into parts, each one of which may be multiply instantiated. A particular computing center may include parts for more than one server. Some parts may be shared between servers.

In an exemplary embodiment of the invention, multiple instantiations of multicast carousel 320 and requests server 318 are provided, to help deal with the traffic passing through them. Alternatively or additionally, multiple instantiations of content builder 318 are provided, for example to provide better communications with server 310. Statistics center 314, for example, may be singly and centrally instantiated, however, it may also be multiply instantiated, either at the same center or at different centers.

In embodiments where multiple servers 308 are provided, the servers may be independent of each other. Alternatively, a central master server (not shown) may transfer information and/or load balance between the servers.

When two users (agents) access a same multicasting channel (view a same WWW page), they do not usually view the page at exactly the same time. Alternatively or additionally, the users do not view the same version of the page, for example, due to personalization. In an exemplary embodiment of the invention, the data for a page is continuously multicast, so each user can connect at a time convenient for him and download only those files that he needs.

In an exemplary embodiment of the invention, server 308 tracks the number and/or frequency of request for a certain page and/or other resource. As the frequency goes up, the server is more likely to start providing the page, create a multicast channel with the page in it and/or provide the page at a greater bandwidth.

As noted above, a configuration 300 can include multiple servers, for example servers associated with particular WWW servers 310 or geographically distributed servers. A single agent 304 may thus connect to more than one server 308, for retrieving a single file or for retrieving different files. In an exemplary embodiment of the invention, agent 304 keeps track of the servers, for example associating with each server different indexes and/or other acceleration parameters, for example average response time.

Channel Start Up

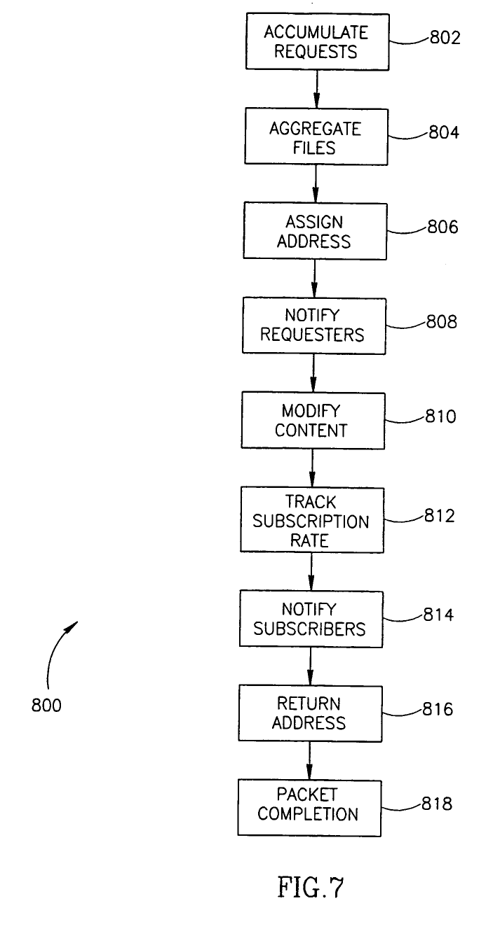

FIG. 7 is a flowchart of a channel life process 800, in accordance with an exemplary embodiment of the invention.

At 802, requests for content are tracked. If a sufficient number of requests are found, a channel, answering these requests may be created.

At 804, it is determined which files to aggregate into the channel.

At 806, the channel is assigned an address. Possibly, there are a limited number of available multicasting channels, requiring that multicasting channels that are not needed, be reused for other content. Once the address is assigned, the channel is officially open and multicasting.

Agents 304 that already downloaded part of the file using other means, such as unicasting or bypassing server 308, may download the balance of the file using the multicast transmission.

At 808, the original requesters, agents 304 and/or other interested parties are notified about the new channel. In an exemplary embodiment of the invention, a service is provided in which a user can request updates when a new channel with particular content is available.

Adding Files

During the life-time of the channel, files may be added to the channel. This is one type of channel content modification (810).

When adding a file to the channel, if the file is part of an already multicast page or site, there may be no need to notify the requesters. Alternatively, various requesters may be notified, for example, those that recently requested a related file.

When content is added to a channel, the channel encoding may be changed. Alternatively or additionally, the channel bandwidth may be increased, for example by requesting greater bandwidth from the routers in the multicasting path and/or by changing the channel address to an address that has a greater bandwidth assigned to it.

Channel Wind-Down

During the channel usage, the number of subscribers to the channel may be tracked (812). If this number goes below a threshold, the channel may be closed, its bandwidth reduced and/or be assigned a new, slower, address. Prior to physically closing the channel, subscribers to the channel are notified (814). In some cases, the notification is explicit, for example by the server sending a closing message to the requesters. In other cases, the closure is implicit, for example, by sending a general update including the channels that are about to be opened, those about to be closed and/or those about to be modified.

At 816, the channel is closed and the address returned to an address pool. However, some agents may have not yet completed the download of data from the channel. In an exemplary embodiment of the invention, a replacement channel is provided, for retrieving additional packets of data. Possibly, a single “closure” channel is shared between several channels, albeit at a slower bandwidth for each channel. The address of this channel may be provided along with the closure notice. In an alternative embodiment of the invention, the agent contacts server 308 for the missing packets and receives them by unicast (818).

In an exemplary embodiment of the invention, a channel address pool is used for providing addresses for new multicast channels.

In some embodiments, tracking the subscription to a channel may be non-trivial. For example, if agents can subscribe to a multi-casting channel without notifying server 308, for example, based on a published index, server 308 may not be aware that the channel was in use at all. Alternatively or additionally, if agents are not required to notify server 308 when use of a channel by an agent is completed, server 308 may be unaware that the channel fell out of use.

In an exemplary embodiment of the invention, agents 304 do notify server 304 of their use and disuse. Possibly, only a sampling of the agents report, so that server 308 has a statistical picture and not complete knowledge of connection to its channel.

Alternatively or additionally, server 308 may be notified by the router and/or may be able to ask the router to report use of its multicasting channels.

Alternatively or additionally, some or all of agents 304 may be required to periodically send a message to server 308, that they are still using a channel. Otherwise, they are assumed to have left the channel. In file type channels, it may be assumed that the file was received after the agent had sufficient time (plus an additional overhead time) to retrieve the file. Alternatively, a file or a packet may have a staleness attribute attached thereto.

In some embodiments of the invention, an agent may request server 308 to continue transmission, at least at the lowest layer of bandwidth. Alternatively or additionally, server 308 may announce until when the transmission of a file or content group will continue and/or the size of the file. Alternatively or additionally, this information may be associated with the index updated in 504.

File Removal and Replacement

Other types of modification 810, are removing and replacing files in the stream. When a file is removed, the event may be treated similar to closing of the channel, except that the address is not returned to a channel address pool. Additionally, even in some embodiments where agent 304 notifies server 308 that he is connecting to a channel, the agent may not notify the server that the agent is viewing a particular file. Alternatively or additionally, a set of files may be managed as a single unit, for example, a file may be removed when files that are aggregated together with it in a single content group, are deemed to be suitable for removal.

When a file is replaced with a new, and different file, the effect may be the same as removing one file and adding another. However, in some cases, a file is replaced with a newer version, and some support may be required for a previous version. In an exemplary embodiment of the invention, the newer file is provided in a new content group and/or a new channel, so that it can be easily differentiated by agent 304. Alternatively or additionally, the file is identified by its UCL (described below) which will be different for the different versions. Alternatively or additionally, an artificial time stamp is attached to the file names, to artificially provide different versions of a same file with different (but optionally related) names. In an exemplary method of support for an older version file, the rate of transmission of packets from the older file is reduced. Possibly, the rate of reduction is timed to match various expected rates of download, so that the download rate will be constant.

With regard to content groups that aggregate several files, in some cases, a file in a content group is replaced and the rest of the content group is unchanged. Optionally, a new content group is created. Alternatively, the old file is removed from the content group, and the new file added.

A distinction may be noted between two different types of file streams, discrete streams, that transmit files, in which a new version may appear periodically or sporadically, and continuous streams, for example video, in which new data is continuously replacing old data. A method for supporting streaming is described below. However, in general, older parts of the stream may also be provided in the channel at lower rates, for example, to match a constant download rate.

Channel Combination

As the frequency goes down and/or the content aggregation changes, channels can be combined together. Alternatively or additionally, channels may be split into separate channels, for example, if requests for a particular part of the channel start growing.

In an exemplary embodiment of the invention, multiple channels and/or content groups may be provided in a single multicasting address, for example, by differently marking packets belonging to the different channels, so that the recipient can ignore those unnecessary packets or by using different ports.

Exemplary Packet Encoding

The files may be multicast in various manners. For example, the files may be divided into packets and sent one file after another. However, if part of a file is missed, the receiver may be required to wait until the transmission repeats itself. In addition, if several files are transmitted in sequence, the receiver must wait until a file he is interested in is being transmitted. Optionally, the packets from different files are interspersed, so that at least part of the file can be received.

In an exemplary embodiment of the invention, a FEC (forward error correction) encoding is used. A desirable property of this type of encoding is that once a sufficient number of packets is received, the file can be reconstructed, substantially independently of the exact packets received.

In an exemplary FEC code, a packet is generated by XORing together a plurality of blocks from the file. Possibly, the probability of a block to be included in a packet is 50%. Alternatively, the probability is higher or lower, for example, 5%, 10%, 20%, 33% or 70%.

In an exemplary embodiment of the invention, the code used is a random code, in which packets are formed by randomly selecting blocks to participate in the packet. Alternatively, a deterministic method may be used. In an exemplary embodiment of the invention, the random code is generated using a seed and a known pseudo-random number generation function. In an exemplary embodiment of the invention, each packet includes an indication of the seed and/or the iteration value of the function, so that the source file parts for the packet can be reconstructed.

To decode the received packets, a set of equations describing the relationship between the packets and the data, is constructed. This set is solved, for example, by matrix inversion.

In an exemplary embodiment of the invention, the file is divided into buckets, so that some buckets can be solved (e.g., inverted) even before the entire file is received.

Although all the packets can be the same, in some embodiments of the invention, cross-bucket packets are defined, which cross-packets define an equation between several buckets. The solution of several a buckets can be used to solve such a cross-packet. The solution of the cross-packet can be used to complete a partially-filled bucket, thus allowing an avalanche effect in solving buckets.

Alternatively or additionally, a bucket may be partially solved before it is filled with packets.

Alternatively or additionally, other codes may be used, such as those mentioned in the background.

Optionally, the data is compressed, typically prior to encoding, using methods known in the art, alternatively or additionally to being encoded.

Differential Encoding

In some embodiments of the invention, the code used allows a data file to be reconstructed if a sufficient number of any packets are received. In an exemplary embodiment of the invention, this property is used to allow differential decoding, in which an agent 304 that is missing X bytes of data of a file of size Y is only required to decode about X bytes.

In an exemplary embodiment of the invention, previously received packets and/or previously decoded data are used to set up the equations. Thus, only a small number of packets are needed to complete a set of equations, which can be solved to yield the complete data file of size Y. Optionally, differential decoding is only applied to whole packets and not to parts of packets.

In an exemplary embodiment of the invention, differential decoding is used for sending file updates, for example, by indicating only those packets that are affected by the file update and which should be replaced when resolving the equations. Optionally, a packet includes an indication if it may be used with an earlier version packet of the file, to achieve an update.

In an exemplary embodiment of the invention, an update transmission includes a list of which files are being updated and/or which packets need to be replaced. Possibly, the files are broken down into parts, before being sent, in a manner that will facilitate updating, for example, a fixed part of the file is encoded in one set of packets and a varying art by another set of packets. Alternatively or additionally, the packet transmission may include an indication of which packets and/or data is being replaced by the new packets.

UCL (Universal Content Locators)

The Internet, as used today, defines a URL as a universal resource locator, an address for locating a resource. In an exemplary embodiment of the invention, a similar scheme is used for content, e.g., UCLs. In a URL, the actual content provided by the resource may change in time. Conversely, in a UCL, even if the location changes, the actual content is always the same.

In an exemplary embodiment of the invention, a UCL is used for guaranteeing delivery of content to an agent 304, when the source sender changes. Alternatively or additionally, a UCL is used to allow an agent to know if packets from different sources can be combined (yes if they are for a same UCL).

In an exemplary embodiment of the invention, a UCL comprises an ID that generally uniquely identifies the content. In an exemplary embodiment of the invention, the UCL is a hash code, for example a 64 bit hash of the file contents. This hash is not expected to repeat itself very often. Alternatively or additionally, a UCL includes a description of the file, for example, a source, publication date, author and/or version.

Optionally, a UCL is attached to every packet. Optionally, a user is sent an identification of the UCL of the file before he receives the file, so the user can determine if to ignore a packet. In an exemplary embodiment of the invention, if UCLs for different files match, a blank UCL is sent instead, indicating the ambiguity.

Optionally, the UCL is used in the index tables (504, above), to identify a source and/or other properties of a file or content group, for example, creation date and aggregation date. Optionally, a separate table is provided for such information, for example for being downloaded after the index is downloaded.

Alternatively or additionally, to files having UCLs, also resource groups (compilations of related files, content groups) can have UCLs. Optionally, a hierarchy of UCLs is defined. This hierarchy may also be used for determining suitability of differential decoding, for example of a single file in a content group. It should be noted that the distribution of files between content groups do not need to match the division used by client 302, for example, if agent 304 re-divides and/or combines the files.

In an exemplary embodiment of the invention, associative caching is based on the UCLs. Possibly, packets are cached (in various places in the Internet) based on them having the same UCL (or content group UCL). Optionally, once a sufficient number of packets is cached for a UCL, no more caching of packets for that UCL are required, even if more are received. Optionally, a packet includes an indication of how many packets are required to reconstruct the file and/or an update, form those packets.

In an exemplary embodiment of the invention, the UCLs are set by the sender, e.g., multicasting carousel 320. Alternatively, UCLs may be generated and/or applied by routers and/or other intra-traffic devices. In an exemplary embodiment of the invention, a router can generate a UCL for a file that passes through the router. This UCL can be transmitted to the target of the file and to a cache service. Alternatively or additionally, the UCL can be matched to a data request that caused the file to be sent.

### Preferential Encoding

Using the scheme described above, different parts of the transmitted file have an equal probability of being decoded first. However, in some instances, it may be desirable that some parts of the file be decoded before other parts. One particular instance is in a multicasting channel in which both data and a script (e.g., JAVA code) for decoding the code are provided. It is generally desirable that the script be received first. Anther particular instance is when viewing WWW pages in which it may be desirable that an advertisement section of the page, or a rough outline of the page, be available before the rest of the page. Optionally, server 310 informs server 308 which parts of the content should be decodable earlier.

In an exemplary embodiment of the invention, preferential reception is provided by transmitted, packets corresponding to those parts of a file or content group that should be received first, at a higher relative rate.

Alternatively or additionally preferential reception is achieved by more often incorporating preferential bits of the file in packets. Thus, effectively, a higher rate of packets including those bits is transmitted.

Streaming

A particular application where preferential reception may be desirable is in the transmission of stream-viewed files. One example of such a file is a movie file, whose viewing lasts 1 hour. Simply multicasting such a file will require an average delay of 1 hour before it can be viewed. If the file is divided up into N parts, each of which is multicast, the average delay will be 1/N hours.

In an exemplary embodiment of the invention, the file is unevenly divided up into N parts, such that the playback time of a part is substantially equally to the expected reception time, decoding time and playback time. Thus, once a first part is being viewed, all the other parts will be ready for viewing when needed. The delay is thus the reception and decoding time of the smallest part. In an exemplary embodiment of the invention, the parts are related by a factor, for example, each part being twice the size of the previous part.

In an exemplary embodiment of the invention, the parts are transmitted using preferential encoding of the different parts, with the first part being most preferentially encoded, the second part less so and so on. Alternatively or additionally, the parts are transmitted by dividing the file into parts and packets from each part being transmitted at a different rate. Optionally, the different parts are transmitted on different multi-casting addresses, rather than on a same address.

Layering and Congestion Control

One potential problem with multicasting is that congestion can form at various parts of the network. In an exemplary embodiment of the invention, receiver driven congestion control is used, in which the receiver responds to reduce the congestion. Alternatively or additionally, centrally driven or router driven congestion control is used.

In an exemplary embodiment of the invention, a simple form of congestion control is applied, in that a router that notes congestion can freely drop any packet.

In an exemplary embodiment of the invention, congestion is detected by agent 304 and/or by server 308, for example, by agent 304 periodically reporting to server 308 an actual rate of packet reception and/or a packet delay time. Server 308 can compare such values for multiple agents 304, thereby generating a map of congestion locations. In an exemplary embodiment of the invention, same content groups are transmitted at multiple data rates on different channels. Server 308 can inform agent 304, which of the different channels is the fastest that the agent can safely receive, so that the agent does not request channels that cause congestion. Alternatively or additionally, congestion is solved, at least temporarily, by unicasting packets causing congestion to agents. Alternatively or additionally, server 308 can stop channels that cause congestion, if the agents do not stop using the high rate channels.

In an exemplary embodiment of the invention, the different rate channels are layered. In one method, all the channels include the same content, albeit at different rates. Alternatively, different channels contain different packets of the same content, so the channels can be combined. Alternatively, some channels include files not found in other channels. Alternatively, the content is distributed between the channels thus that packets from all channels are required for reconstructing the data. This method may be useful in multi-resolution streams, in which a highest resolution requires all the channels to be attended to.

In an exemplary embodiment of the invention, transmission is initiated at one layer and after several packets are transmitted, a signal trigger bit in the packets in updated to indicate that a layer can be advanced to a higher rate layer. Optionally, if the bit is not set for a significant period of time, the layer is reduced.

Optionally, the slowest channel of a content group is used for sending completion blocks for old files in the content group (818 of FIG. 7).

Optionally, a GRA (generic router assistance) type congestion solving method is used. Alternatively or additionally, a multi-layer multi-rate congestion control method, in which each layer is transmitted at a different rate, is used. Alternatively or additionally, the rate of channels automatically goes down with time and an agent must actively connect to a faster channel.

Optionally, in streaming applications, congestion control is achieved by dynamically varying the sub-division of a file into blocks—more blocks if no congestion, fewer if there is congestion.

It should be noted that if a FEC code is used, layering and packet dropping do not necessarily add significant overhead or bandwidth requirements to the transmission system. The following papers describe applications of layering and their disclosures are incorporated herein by reference: S. McCanne, V. Jacobson and M. Vetterli “Receiver Driven Layered Multicast” ACM SIGCOMM, pp. 117-130, 1996, Rubenstein, Dan, Kurose, Jim and Towsley, Don, “The Impact of Multicast Layering on Network Fairness”, Proceedings of ACM SIGCOMM'99, L. Vicisano, L. Rizzo, J. Crowcroft, “TCP-like Congestion Control for Layered Multicast Data Transfer”, IEEE Infocom '98, San Francisco, Calif., Mar. 28-Apr. 1 1998 and Vicisano, L., “Notes On a Cumulative Layered Organization of Data Packets Across Multiple Streams with Different Rates”, University College London Computer Science Research Note RN/98/25, Work in Progress (May 1998).

Modeming

One problem with multicasting is that many parts of the Internet do not support multicasting.

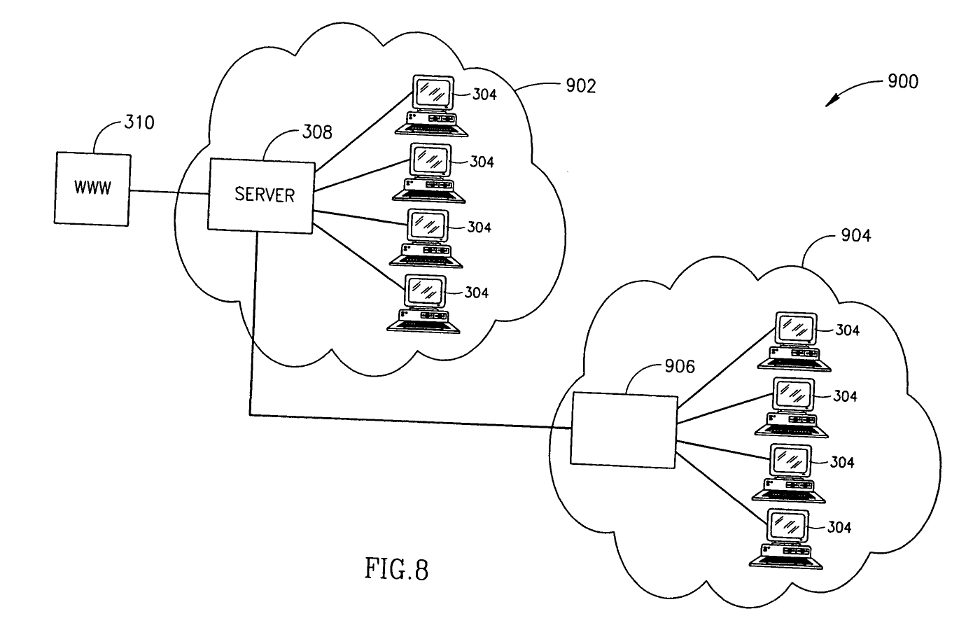

FIG. 8 shows a method 900 of multi-cast modeming, in which multi-cast-enabled domains of the Internet are connected using modem like servers, in accordance with an exemplary embodiment of the invention.

Content from WWW server 310 is disseminated by server 308, using a multicasting protocol, to a plurality of agents 304, in a first part 902 of an Internet. However, agents 304 in a second part 904 of the Internet, cannot connect by multicasting to server 308, for example, if there is no multicasting supporting path between the two parts.

In an exemplary embodiment of the invention, a multicasting server 906 is provided, that receives a unicast transmission from server 308 and broadcasts it using multicasting to agents 304 of Internet part 904. Optionally, multicasting server 906 also serves as a cache.

In a particular implementation, the link connecting server 308 and multicasting server 906 is a satellite link.

Optionally, such a modeming of multicast transmission over unicast lines is used to bypass routers that do not support multicasting and/or ISPs that charge high fees for multicasting.

Alternatively or additionally, multicasting channels are set up per Internet part and/or domain. Thus, when an agent in part 902 receives a content A, it uses a different channel from an agent in part 904. Thus, the actual spread of a multicasting channel may be kept small, for example to within a domain administered by a single ISP. Some routers might not object to multicasting if they are not required to perform any real action on the multicast data, as only a single thread passes through the router.

In an exemplary embodiment of the invention, the division of channels between Internet parts is achieved by indexes set up by server 308 and/or server 906. Alternatively or additionally, server 308 responds differently to requests for files from different Internet parts, e.g., unicasting or multicasting with various channels. Alternatively or additionally, agent 304 determines which channel it should best subscribe to.

Aggregation Points

In an exemplary embodiment of the invention, caching is provided at point in the Internet. Unlike standard caching, what is cached is encoded packets and files, rather than regular data. In an exemplary embodiment of the invention, the local caches are used to drive local broadcasting servers. Data at the caches may be received by unicast or multicast from a main server (e.g. server 308). Optionally, a hierarchy of caches and/or local servers is defined.

Optionally, an agent can bypass a local server/cache, for example, to connect directly to a higher level in the hierarchy. Such a bypass may be temporary or may be permanent, for example if the user is originally from a different geographical location.

Path Reconfiguration

In some exemplary embodiments of the invention, a packet, for example a unicast or a multicast packet, can affect its route and/or processing applied to it on the Internet. In an exemplary embodiment of the invention, server 906 is actually a router. When the router receives a suitably marked UDP packet, the router sends the same packet to multiple IP addresses. In another example, the packet includes instructions to divert the packet to sub-domains of the Internet that include multicasting.

Security

In an exemplary embodiment of the invention, server 308 provides some measure of security for data that it transmits.

One potential security problem is a malicious person inserting incorrect packets into a stream. In an exemplary embodiment of the invention, this problem is solved by acquiring more packets than needed for decoding and solving the over-constrained set of equations, if the solution is not unique, this is an indication of tampering, which can be communicated to server 308. If the degree of tampering is low, the over constraining may suffice to overcome it. Alternatively or additionally, the files are digitally signed, so that after being decoded, they must match the checksum. The UCL may serve as such a checksum. Possibly, the UCL is also expected to match an entry in the index.

Alternatively or additionally, the files are sent in parallel in several streams, so if one is comprised, the agent can connect to a different stream, albeit, a slower or faster stream.

Some domains may use a firewall. In an exemplary embodiment of the invention, agent 304 uses an HTTP-like protocol to connect to server 308, thus bypassing many firewall protection setups.

Privacy and Billing

In many cases, it is desirable to maintain privacy of the transmitted matter. Such privacy may be maintained, to some extent by using unicasting. However, a special type of privacy is the ability to charge for viewing the private data.

Optionally, billing and accounting for charges is handled by agent 304 and then transmitted to server 308 for bill generation and the like. Optionally, server 308 takes into account the difficulty and/or the cost of maintaining certain channels that were used by an agent 304.

In an exemplary embodiment of the invention, the data is encrypted, for example, using a private or public key.

Optionally, data can be transmitted in a manner that defies decoding or make decoding difficult. For example, one or more crucial packets may be sent by unicasting. Alternatively or additionally, cross-bucket packets may be sent by unicasting to subscribers. Alternatively or additionally, a decryption key may be sent by unicast. In an exemplary embodiment of the invention, the packets that are selected for transmission are not random. Instead, certain packets, selected for example based on their constituent file parts, are not sent by multicast.

Alternatively or additionally, garbage packets, that can only be distinguished using a subscriber's code, are transmitted.

In an exemplary embodiment of the invention, most of the bandwidth of a channel uses encrypted blocks, and some uses unencrypted blocks, thus allowing a free (or slow) sample to be provide in a same channel as used for paying customers. Alternatively or additionally, higher-paying customers can decode more of the blocks, for example using server-provided codes.

In an exemplary embodiment of the invention, the information for billing is extracted from reports that agent 304 sends to server 308. In an exemplary embodiment of the invention, the billing information is converted into (or originally sent) a form recognized by standard Internet file and/or bandwidth billing systems.

Exemplary Packet Formats

In an exemplary implementation of the invention the packets sent by server 308 include one or more of the following packet types.

A. Service announcer packets, which supply meta-information to agents 304, containing information regarding, for example, one or more of:

(a) The identification of content groups being accelerated by the system.

(b) The identification of files in the content groups and/or file details such as file size, packet size, block division and coding/or method.

(c) Locations information for content groups (e.g., channel, router and/or server identification).

B. Log report packets, which supply information from agents 304 to server 308, containing information regarding, for example, one or more of:

(a) Usage of multicast content groups (e.g., Hits).

(b) Various temporal measures, for example, average (or exact) elapsed time between initial request of data until completion.

C. Data transmission packets comprising:

(a) A standard IP header consisting of 20 bytes.

(b) A transport header consisting of between 8-12 bytes. The header can include, for example, an indication of the type of transport (e.g., multicast, reliable UDP or Broadband content on demand). In a multicast packet, for example, the header comprises (besides the indication):

| | |
|---|---|
| Increase signal trigger (e.g., can a layer be advanced) | 1 bit |
| Time slot index | 7 bits |
| (e.g., a temporal ID shared by a group of packets sent together) | |
| Group number | 8 bits |
| Sequence number (in the group) | 16 bits |
| Destination address | 16 bits |
| IP address | 16 bits |

(c) A FEC code header containing

| | |
|---|---|
| Block number in stream or 0 | 16 Bits. |
| Standard packet or cross packet | 1 Bit. |
| Packet number in the bucket or row for cross packet | 15 Bits. |
| Probability of block participation in a packet | 3 Bits. |
| (0 = no encoding, otherwise p = 100/2\hat{ }bits) | |
| Random seed for choosing participating bits | 29 Bits. |

(d) A FEC payload containing the actual encoded data. (all the other bytes in the packet)

Variations

Following are some variations on the above system configuration. These variants have, at least in part, been mentioned above, however, the repetition is intended for emphasizing.

Agent 304 retrieves encoded data and, after decoding sends the data to user 302. This is an integral view, in that the decoded data is transferred as a whole. Alternatively, a transactional view may be provided, in which agent 304 transfers data as it is decoded. This partial data may be used for progressive display of received images. Alternatively, the agent is integrated into the browser, so the data can be used as it is decoded.

In an exemplary embodiment of the invention, the system, as a whole, is transparent to the user, excepting possibly, for example, the user's agreement to use the system. Alternatively, for example, a user may deliberately sign-up to download data from an encoded multicast stream.

Another variation relates to time stamping. In an exemplary embodiment of the invention, packets are time stamped. However, the time stamp is relative, rather than absolute, for example, to assist in reconstructing the seed values. Alternatively or additionally, the time stamp is used to determine when the packet is stale. In an exemplary embodiment of the invention, if a packet is nearly stale, the agent can send a request to the server to continue sending the packets, at least to him, so the agent can reconstruct a complete file.

Another variation relates to the size of the packets. Alternative to packets of a standard size, a continuous bit stream may be used to transmit the information. The effective block size is one bit. The value of the seed may be linked, for example, to a time clock, so that the data bits that take part in each bit of transmission can be reconstructed.

An additional variation is using multiple servers, for example, to allow an agent to connect to multiple servers at the same time. The use of FEC encoding can reduce the danger of redundant data being retrieved.

Net Acceleration for Unicasting

The above system may be used for network (e.g., Internet) acceleration of unicast data. In an exemplary embodiment of the invention, the acceleration is achieved by multicasting the data, thus reducing the load at server 308 and/or at some parts of the Internet.

Alternatively or additionally, the overhead associated with TCP/IP is overcome using methods described above for unicasting and/or multicasting. For example, some types of feedback mechanisms in TCP/IP can be avoided by the use of FEC codes as described above. Alternatively or additionally, the “slow-start” problem is solved by the availability of multiple multicasting channels available.

In an exemplary embodiment of the invention, agent 304 is integrated into the browser of client 302. Optionally, the integration allows partially reconstructed data to be displayed by the browser.

Net Acceleration for Multicasting

The above system may alternatively or additionally be used to enhance “standard” multicasting of data. Following is a list of potential problems with multicasting and manners in which they may be overcome, using methods as described above.

A. Many ISPs object to multicasting on the grounds that it might cause congestion, as multicasting is not a “nice” protocol like TCP/IP. In an exemplary embodiment of the invention, various congestion detection and solving methods, for example, as described above, are used. Alternatively or additionally, the congestion may be limited to the ISP's domain, in a manner which allows the ISP better control over the source of the congestion, for example, by arranging the multicasting channels by ISPs and/or by the ISP communicating with server 906.

B. Not all routers support multicasting. Using modeming, for example as described in FIG. 8, allows avoiding such routers.

C. Switching multicasting is slower than switching unicasting, so fewer multicasting streams can be supported by a router. In an exemplary embodiment of the invention, server 308 takes this into account when deciding if to unicast or multicast and the extent (on the Internet) of the multicast channel.

D. Modeming can also overcome inter-domain connectivity requirements of pre-SSM multicasting protocols.

E. Billing for multicasting is complex. In an exemplary embodiment of the invention, by organizing the multicasting channels, cross-ISP multicasting connections are reduced or eliminated, allowing each ISP to charge for multicasting in a desired, expense-covering manner.

F. Reliability of multicasting is enhanced by using forward correcting codes, multiple channels and/or UCLs, reducing or eliminating the need for large scale feedback.

G. The code and/or layering protocols also allow various tradeoffs between quality of service, rate control and delay control

UDP Streaming

By combining the UDP protocol with FEC coding, as described above, a substantially reliable UDP transmission method can be achieved. This method can be used, for example, for streams and other resources.

Update Application

The above system can be used for updating software and/or continuously publishing versions and fixes. It should be noted that a client can download substantially any packet at any time and accumulate these packets until a complete version can be reconstructed. Thus, downloading is simpler and less sensitive to interruption.

Reporting Application

Pretty reliable UDP may also be used for various reporting applications, for example, for reporting information such as lists of used e-money tokens and/or for internal system uses, such as publishing indexes (see 504).

Broadband Content on Demand Application

In an exemplary embodiment of the invention, configuration 300 is used for transmitting broadband content on demand. For example, such content can include one or more of: jukeboxes, video (and other media) rentals and purchase, cable programs, books and/or documents.

It should be noted that configuration 300, in some embodiments, can also utilize slow lines and noisy lines.

In an exemplary embodiment of the invention, the content can be displayed as it is being provided. An exemplary such application is transmission of movies on demand in cable networks.

Telephony Applications

Configuration 300 can also be implemented for non-Internet networks, for example, land telephony, cellular telephony, wireless communicators and satellite communications. Exemplary uses include, modem communications, media streaming, cell broadcasting, and various voice and data information services. In an exemplary embodiment of the invention, the applications make use of the ability to browse through a tree of information, without being required to actually send feedback to the information source. The multicasting may reach the individual device (e.g. telephone). Alternatively, the agent may reside at the base station or at a cellular center.

Network Traffic Application

In an exemplary embodiment of the invention, configuration 300 is used in a data network, for example, a LAN, such as a star network or a linear network. The use of an FEC code allows clashes between transmitters to be ignored, inasmuch that the loss of a small number of packets can be ignored and does not add overhead. This also allows the transmission of large files over a LAN without fear of blocking the LAN and without special scheduling algorithms. Relatively small packets may be desirable.

Exemplary networks, include Ethernet and BlueTooth.

In an alternative embodiment, an agent is provided at a gateway to a network segment, for translating encoded information received outside, into the network protocol. Optionally the gateway is two way, also translating activity inside the network into encoded packets, for example, using two such agents to interconnect two interconnected LANs.

Radio Applications

In an exemplary embodiment of the invention, the above transmission method is used for transmitting voice and/or data over broadcast radio networks, for example allowing a program to be received at multiple starting points and/or over the entire day.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of emulating an interactive connection, comprising:
generating a request for interactive data from an interactive server, at a client;
intercepting said request by an agent;
responsive to said request, retrieving at least some of said data from a continuous retransmission of said data, by said agent; and
displaying said data including said retrieved data at said client.

2. A method according to claim 1, wherein said agent emulates cookies for said client.

3. A method according to claim 1, wherein said agent emulates an HTTP connection for said client.

4. A method according to claim 1, wherein said agent is located at said client.

5. A method according to claim 1, wherein said agent is located at a different site from said client.

6. A method according to claim 1, comprising continuously retransmitting files to create said stream.

7. A method according to claim 6, comprising grouping files into content groups for the purpose of adding or removing groups from said continuous retransmission.

8. A method according to claim 1, wherein said retransmission comprises a multicast retransmission.

9. A method according to claim 1, wherein said retransmission comprises a unicast retransmission.

10. A method according to claim 1, wherein said data in said retransmission is encoded using a FEC (forward error correction) code.

11. A method according to claim 1, wherein retrieving comprises retrieving from a plurality of retransmission sources in parallel.

12. A method according to claim 1, comprising retrieving some of said data from said interactive server, in response to said request.

13. A method according to claim 1, comprising updating a content of said retransmission in response to said request.

14. A method according to claim 1, wherein a content of said retransmission is independent of said request, during said retrieving.

15. A method according to claim 1, wherein said displaying comprises personalized information for a particular user.

16. A method according to claim 1, comprising:
determining congestion by a network element along a path of said retransmission; and
reducing said congestion by unilateral dropping of packets by said network element.

17. A method according to claim 16, wherein said network element comprises a router.

18. A method according to claim 1, comprising determining by said agent a source for said data.

19. A method according to claim 18, wherein said determining comprises checking against an index.

20. A method according to claim 18, wherein said determining comprises analyzing said request.

21. A method according to claim 18, wherein said determining comprises querying a file distribution server.

22. A method according to claim 1, wherein said data is retrieved from a multi-layer stream.

23. A method according to claim 22, wherein said agent selects which layers to be used for retrieval responsive to available bandwidth.

24. A method according to claim 1, wherein said agent stores locally at least some data and wherein said agent downloads only enough data as needed for reconstructing said data in view of the locally stored data.

25. A method of transmitting a plurality of files, comprising:
combining said files into a content group, at a content combiner;
encoding said content group using a FEC (forward error correction code); and
continuously retransmitting said encoded files.

26. A method according to claim 25, comprising stopping said retransmission if fewer than a certain number of receivers are listening to said transmission.

27. A method according to claim 26, comprising continuing to transmit at least some of said encoded files to said listening receivers, using a different transmission method than used for said continuously retransmitting.

28. A method according to claim 25, comprising:
retrieving said encoded content group by an agent program; and
converting said encoded content group into files, for use by a file oriented target program.

29. A method according to claim 28, wherein said agent emulates an interactive connection for a user of said target program using said file.

30. A method according to claim 28, wherein said combining comprises combining responsive to statistics gathered by said agent.

31. A method according to claim 30, comprising generating hit statistics for content sources based on said statistics.

32. A method according to claim 31, comprising transmitting said hit statistics to operators of said content sources.

33. A method according to claim 28, comprising transmitting at least a part of said agent as a part of a content group.

34. A method according to claim 33, wherein a bootstrap part of said agent is transmitted in a preferential manner over other parts of said agent.

35. A method according to claim 25, comprising transmitting update information, for differential decoding relative to previously received content groups.

36. A method according to claim 25, wherein said update information comprises replacement files.

37. A method according to claim 25, wherein said update information comprises software updates.

38. A method according to claim 25, comprising transmitting an index of content groups and locations where said content groups are available for retrieval.

39. A method according to claim 38, wherein at least a part of said index is encoded in a preferential manner so that that part is preferentially received before other parts of said index.

40. A method of locating information on an Internet, comprising:
providing a content locator for the information, said content locator being defined as a hash function of said information; and
searching for data having a content locator matching said content locator in a plurality of Internet sites having unrelated owners.

41. A method according to claim 40, comprising analyzing said information to determine if it matches said content locator.

42. A method according to claim 40, comprising generating a content locator for new data prior to the data being broadcast.

43. A method according to claim 40, wherein searching comprises searching in an index that matches content locators and storage locations.

44. A method of reliable UDP transmission of a data file, comprising;
encoding said data file using FEC (forward error correction) encoding into a plurality of packets;
transmitting said packets using a UDP protocol.

45. A method according to claim 44, wherein said encoding comprises continuously generating new packets for said stream, independent of a length of said data file.

46. A method of emulating multicasting, comprising:
determining by a multicasting server a list of clients desiring a multicast transmission;
generating a stream of packets for said transmission;
duplicating said packet stream; and
unicasting said packets to said clients.

47. A method according to claim 46, wherein duplicating comprises duplicating using a zero socket duplication method.

48. A method of file transmission, comprising:
collecting request statistics for at least two files;
determining that requests for at least two files by a plurality of users are correlated part of the time but not all of the time;
grouping said two files into a group; and
continuously retransmitting said group by multicasting.

49. A method according to claim 48, wherein said determining comprises determining according to geographical origins of said requests.

50. A method of reduced multicasting, comprising:
announcing the existence of a multicasting location;
listening for requests to connect to the multicasting location; and
building a multicasting tree on a host of said multicasting location only in response to a request to connect.

51. A method according to claim 50, comprising stopping transmission of content on said tree when a count of requesters reaches zero.

52. A method of multicasting a plurality of channels, comprising:
multicasting a plurality of channels, each channel having a respective content; and
multicasting an index channel listing at least an identification of said channels and an indication of their respective content.

53. A method according to claim 52, wherein said index includes an indication of a geographical region served by said channel.

54. A method of multicasting over an Internet, comprising:
generating a multicast transmission at a first location;
converting said multicasting transmission into a unicast transmission at a second location, for transmission to a third location over a part of said Internet that does not support multicasting;
converting said unicast transmission into a multicast transmission at said third location.

55. A method according to claim 54, comprising transmitting said transmission using unicast transmission to a plurality of clients in said part of said Internet.

56. A method according to claim 54, wherein a transmission from said first part to said second part is by a satellite.

57. An interactive file transmission accelerator, comprising:
a file encoder that encoding a plurality of files using an FEC code, into encoded packets;
a broadcast transmitter that transmits said packets in a non-personalized transmission; and
an agent receiver associated with a user operative to emulate, to a user, an interactive connection to a file source of said files.

58. An accelerator according to claim 57, wherein said broadcast transmitter comprises a multicast transmitter.

59. An accelerator according to claim 57, wherein said broadcast transmitter comprises a multiple unicast transmitter that sends a same unicast transmission to a plurality of agent receivers.

60. An accelerator according to claim 57, wherein said file source is at a different site from said file encoder.

61. An accelerator according to claim 60, wherein said file source is connected to said file encoder by an Internet.

62. An accelerator according to claim 57, comprising a user computer, wherein said user computer is at a different site from said agent receiver.

63. An accelerator according to claim 62, wherein said agent is connected to said user computer via an Internet.

64. An accelerator according to claim 57, comprising at least one cache for packets on an Internet path interconnecting said transmitter and said agent.

65. An accelerator according to claim 57, comprising at least re-broadcasting station on an Internet path interconnecting said transmitter and said agent, for local broadcasting of said packets.

66. An accelerator according to claim 57, comprising a plurality of reception agent for different users, each of said reception agents having a different reception bandwidth for said transmission.

67. A method of broadcasting non-computer media information, comprising:
encoding a media file into encoded data a FEC code;
broadcasting said encoded data;
receiving said encoded data by a plurality of receivers;
reconstructing said media at said plurality of receivers; and
wherein each of said receivers has a different data reception rate.

68. A method according to claim 67, wherein each of said receivers has a noise rate for said transmission.

69. A method according to claim 67, wherein broadcasting comprises broadcasting by radio.

70. A method according to claim 67, wherein broadcasting comprises broadcasting by cable TV.

71. A method according to claim 67, wherein broadcasting comprises broadcasting by satellite.

72. A method according to claim 67, wherein encoding comprises encoding into packets.
